(19) United States
(12) Patent Application Publication
(10) Pub. No.: US 2025/0056548 A1
(43) Pub. Date: Feb. 13, 2025

(54) UPDATING SYSTEM INFORMATION FOR REDUCED CAPABILITY USER EQUIPMENT

(71) Applicant: QUALCOMM Incorporated, San Diego, CA (US)

(72) Inventors: Jing LEI, San Diego, CA (US); Ruiming ZHENG, Beijing (CN); Linhai HE, San Diego, CA (US); Peter GAAL, San Diego, CA (US)

(21) Appl. No.: 18/720,350

(22) PCT Filed: Feb. 11, 2022
(86) PCT No.: PCT/CN2022/075980

§ 371 Date: Jun. 14, 2024

(51) Int. Cl. H04W 72/23; H04W 74/0833; H04W 76/27

(52) U.S. Cl. CPC H04W 72/23; H04W 74/0833; H04W 76/27

(57) ABSTRACT

Certain aspects of the present disclosure provide techniques for updated system information (SI) delivery. In some cases, a method performed by a user equipment may include receiving, from a network entity, a configuration for a common control resource set (CORESET) on a first downlink bandwidth part (BWP) and a configuration for one or more common search space (CSS) sets within the common CORESET for physical downlink control channel (PDCCH) monitoring. The method may further include receiving, from the network entity on the first downlink BWP, a first set of system information (SI) scheduled by a physical downlink control channel (PDCCH) in the one or more CSS sets, and receiving, from the network entity on a second downlink BWP, updated SI or an indication of updated SI.

### INTRODUCTION

Aspects of the present disclosure relate to wireless communications, and more particularly, to techniques for signaling updated system information.

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communication by a user equipment (UE), including receiving, from a network entity, a configuration for a common control resource set (CORESET) on a first downlink bandwidth part (BWP); receiving, from the network entity, a configuration for one or more common search space (CSS) sets within the common CORESET for physical downlink control channel (PDCCH) monitoring; receiving, from the network entity on the first downlink BWP, a first set of system information (SI) scheduled by a physical downlink control channel (PDCCH) in the one or more CSS sets; and receiving, from the network entity on a second downlink BWP, updated SI or an indication of updated SI.

One aspect provides a method for wireless communication by a network entity, including transmitting, to a UE, a configuration for a common CORESET on a first downlink BWP; transmitting, to the UE, a configuration for one or more CSS sets within the common CORESET for PDCCH monitoring; transmitting, to the UE on the first downlink BWP, a first set of SI scheduled by a PDCCH in the one or more CSS sets; and transmitting, to the UE on a second downlink BWP, updated SI or an indication of updated SI.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example of a base station and user equipment.

FIGS. 3A, 3B, 3C, and 3D depict various example aspects of data structures for a wireless communication network.

FIG. 4 depicts an example new radio (NR) reduced capability (RedCap) user equipment (UE).

FIG. 5A and FIG. 5B depict call flow diagrams for 2-step and 4-step random access channel (RACH) procedures, respectively.

FIG. 6 illustrates an example association of SSBs to RACH occasions (ROs).

FIG. 7 illustrates example features for RedCap and non-RedCap bandwidth parts (BWPs).

FIG. 8 depicts a call flow diagram for 2-step RACH based small data transmission (SDT), according to aspects of the present disclosure.

FIG. 9 depicts a call flow diagram for 4-step RACH based SDT according to aspects of the present disclosure.

FIG. 10 depicts a call flow diagram for configured grant (CG) based SDT according to aspects of the present disclosure.

FIG. 11 depicts an example frequency resource allocation for bandwidth parts (BWPs) configured for a UE.

FIG. 12 depicts another example frequency resource allocation for BWPs configured for a UE.

FIG. 13 depicts a UE switching between BWPs to obtain modified system information (SI), according to aspects of the present disclosure.

FIG. 14 depicts a call flow diagram for updated SI delivery during a 2-step RACH based SDT procedure, according to aspects of the present disclosure.

FIG. 15 depicts a call flow diagram for updated SI delivery during a 4-step RACH based SDT procedure, according to aspects of the present disclosure.

FIG. 16 depicts a call flow diagram for updated SI delivery during a CG based SDT procedure, according to aspects of the present disclosure.

FIGS. 17 and 18 depict example processes of wireless communication according to aspects of the present disclosure.

FIGS. 19 and 20 depict example communication devices according to aspects of the present disclosure.

FIG. 21 depicts an example disaggregated base station architecture.

### DETAILED DESCRIPTION

Aspects of the present disclosure provide apparatuses, methods, processing systems, and computer-readable mediums for delivery of updated system information (SI) to a UE that may be configured to operate in a bandwidth part (BWP) not typically used for updated SI delivery.

Different types of UEs may have capabilities tailored to suit certain objectives. For example, some UEs may be designed to be scalable and deployable in a more efficient and cost-effective way. These types of UEs may have reduced capabilities (RedCap) relative to conventional (more expensive) UEs, such as high-end smart phones. RedCap UEs may have reduced latency and/or reliability requirements.

A network may configure a separate frequency resources, referred to as bandwidth parts (BWPs) for RedCap UEs to perform certain functions, such as random access channel (RACH) procedures. In some cases, a RedCap UE may have only a single radio (e.g., to control cost), meaning it may be able to operate on only one BWP at a time. This may present certain challenges, however, as it may require the UE to retune its radio to receive certain types of signals used for certain purposes.

For example, the network may configure a RedCap UE with a downlink BWP (dedicated for RedCap UEs) that does not have certain mechanisms used for transmitting updated system information (SI) that may be useful or necessary to a RedCap UE. As a result, the RedCap UE would have to switch between the dedicated downlink BWP and a BWP used for signaling SI updates. This switching may result in increased latency and increased power consumption to acquire SI updates.

Aspects of the present disclosure, however, provide mechanisms for efficiently signaling SI updates to certain types of UEs, such as RedCap UEs. According to such mechanisms, the network may signal updated SI via a small data transfer (SDT) to a UE (in an idle, inactive, or connected state) on a dedicated downlink BWP, so the UE may acquire the updated SI without switching to another BWP. In some cases, the network may provide an indication, via signaling on the dedicated downlink BWP, notifying the UE that there is updated SI available. In such cases, the UE may only switch to the other BWP to acquire the updated SI after receiving the notification.

By avoiding BWP switching to acquire SI updates, or by limiting switching to when updated SI is available, aspects of the present disclosure may help reduce latency and power consumption associated with acquiring SI updates.

### Introduction to Wireless Communication Networks

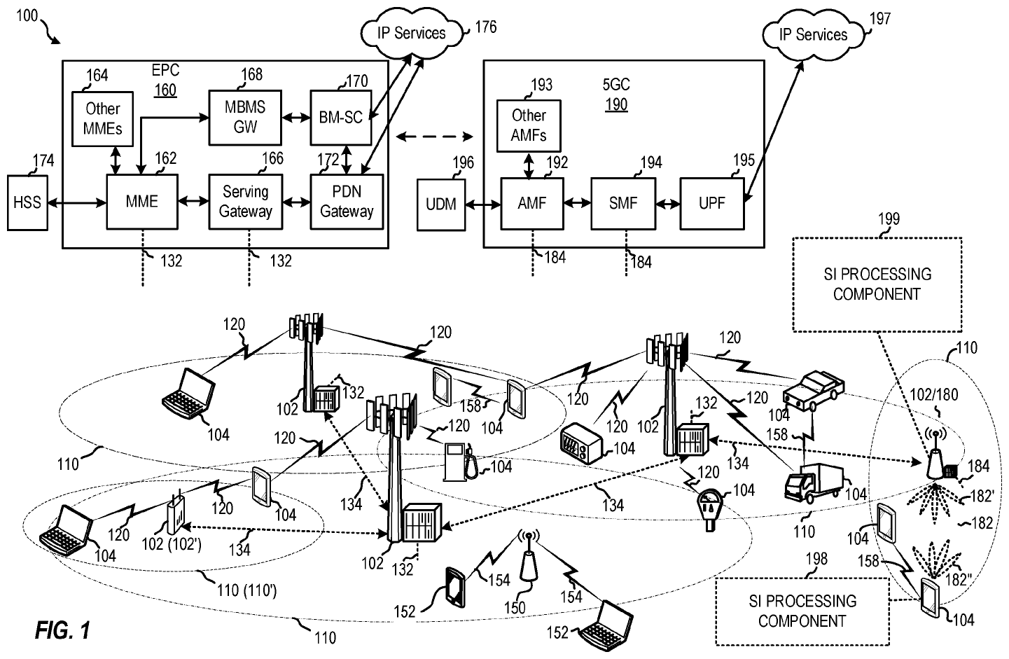

FIG. 1 depicts an example of a wireless communication network 100, in which aspects described herein may be implemented.

Generally, wireless communication network 100 includes base stations (BSs) 102, user equipments (UEs) 104, one or more core networks, such as an Evolved Packet Core (EPC) 160 and 5G Core (5GC) network 190, which interoperate to provide wireless communications services.

BSs 102 may provide an access point to the EPC 160 and/or 5GC 190 for a UE 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

A base station, such as BS 102, may include components that are located at a single physical location or components located at various physical locations. In examples in which the base station includes components that are located at various physical locations, the various components may each perform various functions such that, collectively, the various components achieve functionality that is similar to a base station that is located at a single physical location. As such, a base station may equivalently refer to a standalone base station or a base station including components that are located at various physical locations or virtualized locations. In some implementations, a base station including components that are located at various physical locations may be referred to as or may be associated with a disaggregated radio access network (RAN) architecture, such as an Open RAN (O-RAN) or Virtualized RAN (VRAN) architecture. In some implementations, such components of a base station may include or refer to one or more of a central unit (CU), a distributed unit (DU), or a radio unit (RU).

BSs 102 wirelessly communicate with UEs 104 via communications links 120. Each of BSs 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between BSs 102 and UEs 104 may include uplink (UL) (also referred to as reverse link) transmissions from a UE 104 to a BS 102 and/or downlink (DL) (also referred to as forward link) transmissions from a BS 102 to a UE 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

Wireless communication network 100 includes SI processing component 199, which may help a network entity (e.g., a base station 103) configure one or more aspects of updated SI processing by UEs 104. Wireless communication network 100 further includes SI processing component 198, which may be used to perform updated SI processing by a UE 104.

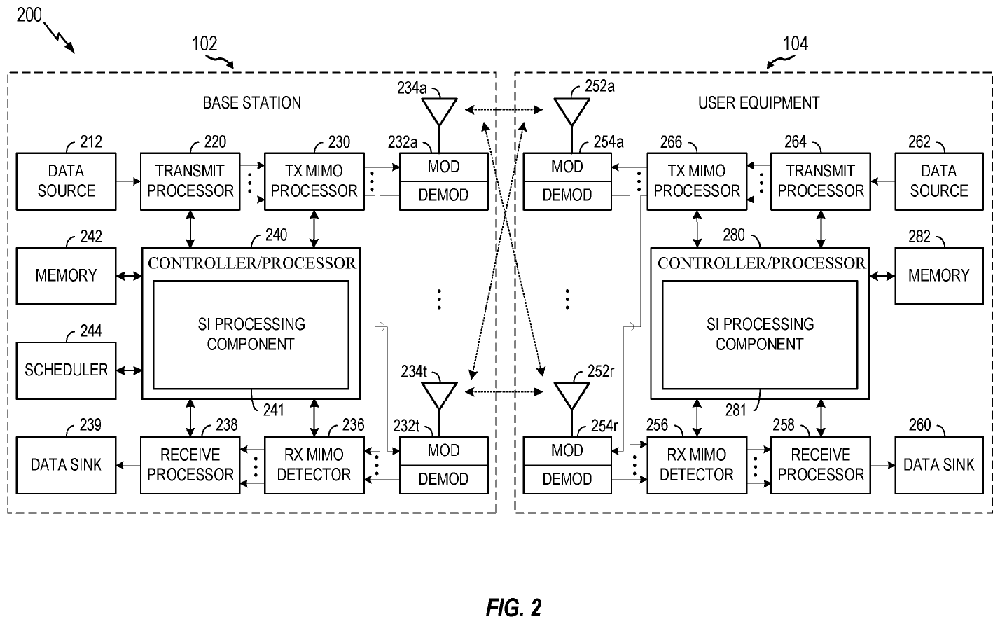

FIG. 2 depicts aspects of an example BS 102 and a UE 104. Generally, BS 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, BS 102 may send and receive data between itself and UE 104.

BS 102 includes controller/processor 240, which may be configured to implement various functions related to wireless communications. In the depicted example, controller/processor 240 includes SI processing component 241, which may be representative of SI processing component 199 of FIG. 1. Notably, while depicted as an aspect of controller/processor 240, SI processing component 241 may be implemented additionally or alternatively in various other aspects of BS 102 in other implementations.

Generally, UE 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

UE 104 includes controller/processor 280, which may be configured to implement various functions related to wireless communications. In the depicted example, controller/processor 280 includes SI processing component 281, which may be representative of SI processing component 198 of FIG. 1. Notably, while depicted as an aspect of controller/processor 280, SI processing component 281 may be implemented additionally or alternatively in various other aspects of UE 104 in other implementations.

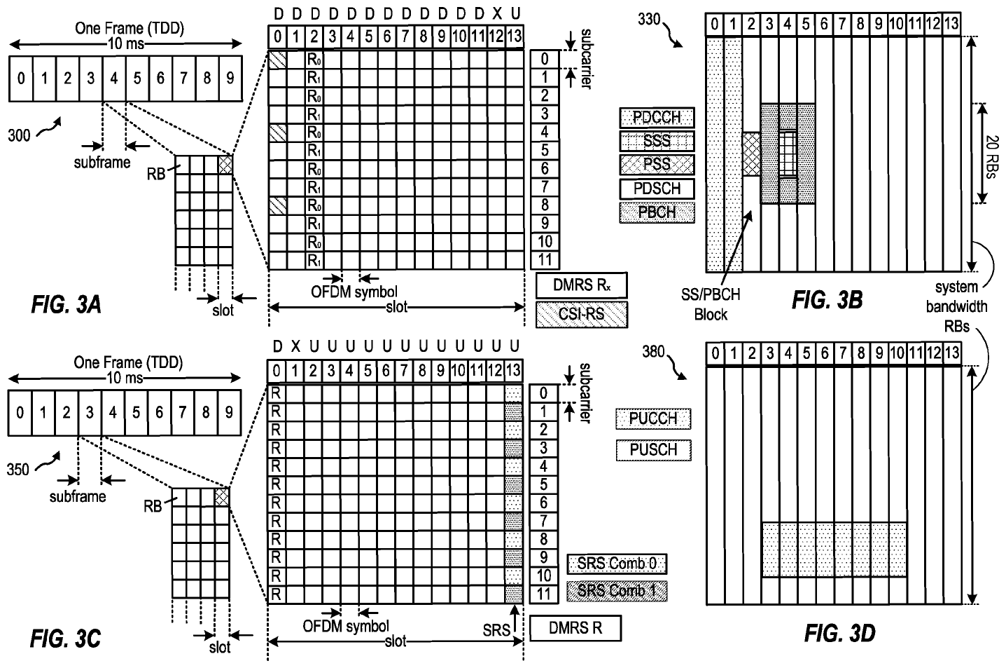

FIGS. 3A, 3B, 3C, and 3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A, 3B, 3C, and 3D are provided later in this disclosure.

### Example Reduced Capability (RedCap) UE

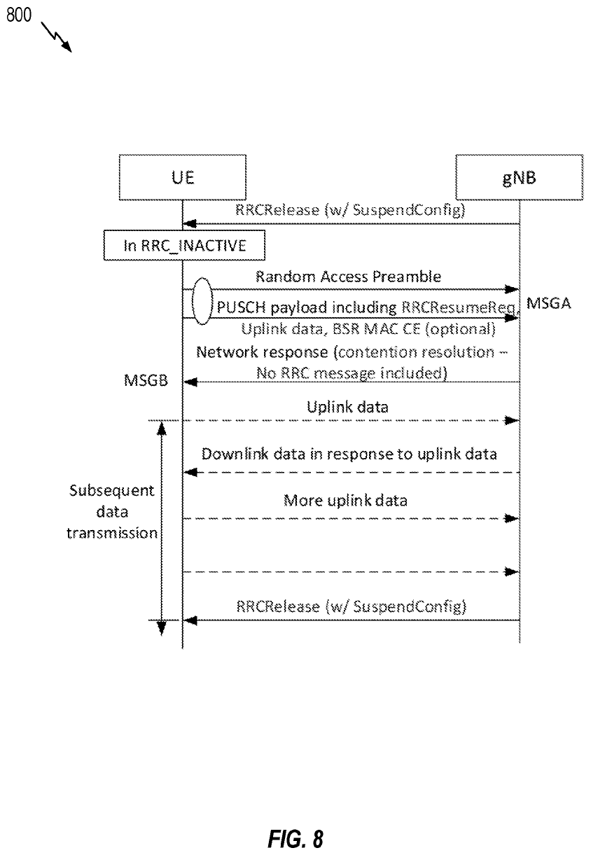

Various technologies may be the focus of current wireless communication standards. For example, Rel-15 and/or Rel-16 may focus on premium smartphones (e.g., enhanced mobile broadband (eMBB)), and other verticals such as ultra-reliable low latency communication (URLLC) and/or vehicle-to-everything (V2X) communications. In some wireless communication standards (e.g., Rel-17 and beyond) there may exist a strong desire for new radio (NR) to be scalable and deployable in a more efficient and cost-effective way. Thus, a new UE type with reduced capabilities (RedCap) has been introduced. RedCap UE may exhibit a relaxation of peak throughput (e.g., 20 MHz), as well as lower latency and/or reliability requirements. Also, the RedCap UE may involve lower device cost (and complexity) and improved efficiency (e.g. power consumption, system overhead, and cost improvements) as compared to high-end devices, such as high-end eMBB and URLCC devices of 5G NR Rel-15/16 (e.g., high-end smartphones). In some cases, a cell may allow access for a RedCap UE. A network can configure a separate initial UL BWP for RedCap UEs in a system information block (SIB) which may be used both during and after initial access. A RedCap UE may not be configured to support a BWP wider than the maximum bandwidth of the initial BWP for the RedCap UE; however, a non-RedCap UE, which may share an initial UL BWP with the RedCap UE, is allowed to exceed the maximum bandwidth of the initial BWP. The RedCap UE may switch to a non-initial BWP by using the BWP switching mechanisms described in FIG. 8 below.

For many use cases, a RedCap UE may be implemented with a device design having a more compact form factor. RedCap UEs may also support frequency range (FR) 1 and/or 2 bands for frequency division duplexed (FDD) and/or time division duplexed (TDD) communications. For F1, a basic BWP operation with restriction may be used as a starting point for RedCap UE capability. Alternatively, basic BWP operation without restriction may be used as a starting point for RedCap UE capability. For FR1 in TDD, center frequencies may be the same for the initial DL and UL BWPs used during random access for RedCap UEs. Center frequencies may be the same for a non-initial DL and UL BWPs with the same BWP identifier (BWP ID) for a RedCap UE.

Thus, some design objectives of the NR RedCap UE may include scalable resource allocation, coverage enhancement for DL and/or UL, power saving in all RRC states, and/or co-existence with the NR premium UE.

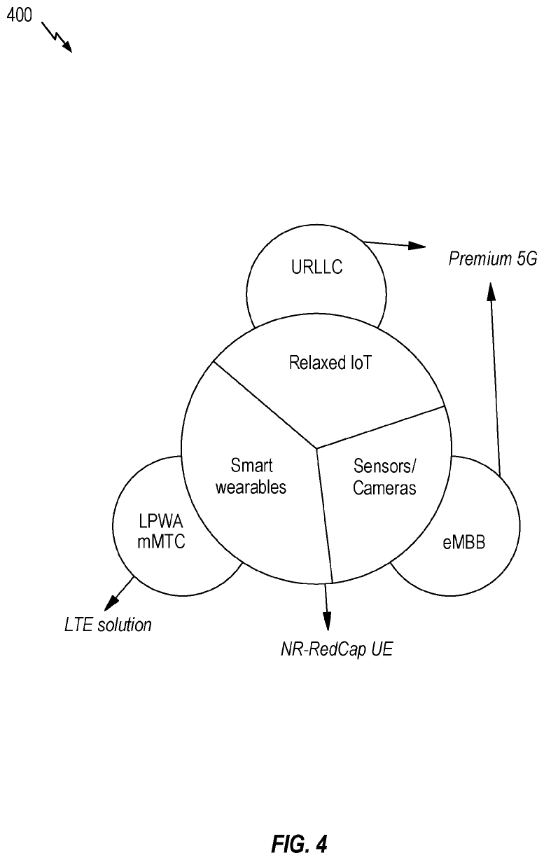

As shown in FIG. 4, an NR-RedCap UE may be a smart wearable device, a sensor/camera, or any other device configured for relaxed internet-of-things (IoT) communications. Further, a RedCap UE functionality and/or capability may overlap with those of long term evolution (LTE) and/or fifth generation (5G) devices (e.g., premium 5G devices). For example, the functionality of relaxed IoT devices may overlap with that of URLLC devices, the functionality of smart wearable devices may overlap with that of low power wide area (LPWA) massive machine type communication (mMTC) devices, and/or the functionality of sensors/cameras may overlap with that of eMBB devices.

### Example RACH Procedures

A random-access channel (RACH) is so named because it refers to a wireless channel (medium) that may be shared by multiple UEs and used by the UEs to (randomly) access the network for communications. For example, the RACH may be used for call setup and to access the network for data transmissions. In some cases, RACH may be used for initial access to a network when the UE switches from a radio resource control (RRC) connected idle mode to active mode, or when handing over in RRC connected mode. Moreover, RACH may be used for downlink (DL) and/or uplink (UL) data arrival when the UE is in RRC idle or RRC inactive modes, and when reestablishing a connection with the network.

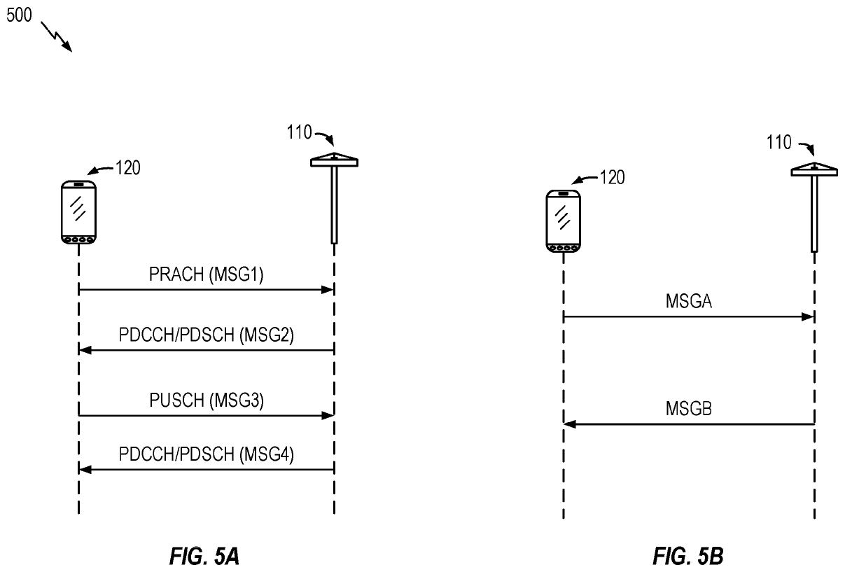

FIG. 5A is a timing (or “call-flow”) diagram illustrating an example four-step RACH procedure, in accordance with certain aspects of the present disclosure. A first message (MSG1) may be sent from the UE 104 to BS 102 on the physical random access channel (PRACH). In this case, MSG1 may only include a RACH preamble. BS 102 may respond with a random access response (RAR) message (MSG2) which may include the identifier (ID) of the RACH preamble, a timing advance (TA), an uplink grant, cell radio network temporary identifier (C-RNTI), and a back off indicator. MSG2 may include a PDCCH communication including control information for a following communication on the PDSCH, as illustrated. In response to MSG2, MSG3 is transmitted from the UE 104 to BS 102 on the PUSCH. MSG3 may include one or more of a RRC connection request, a tracking area update request, a system information request, a positioning fix or positioning signal request, or a scheduling request. The BS 110 then responds with MSG 4 which may include a contention resolution message.

In some cases, to speed access, a two-step RACH procedure may be supported. As the name implies, the two-step RACH procedure may effectively “collapse” the four messages of the four-step RACH procedure into two messages.

FIG. 5B is a timing diagram illustrating an example two-step RACH procedure, in accordance with certain aspects of the present disclosure. A first enhanced message (msgA) may be sent from the UE 104 to BS 102. In certain aspects, msgA includes some or all the information from MSG1 and MSG3 from the four-step RACH procedure, effectively combining MSG1 and MSG3. For example, msgA may include MSG1 and MSG3 multiplexed together such as using one of time-division multiplexing or frequency-division multiplexing. In certain aspects, msgA includes a RACH preamble for random access and a payload. The msgA payload, for example, may include the UE-ID and other signaling information (e.g., buffer status report (BSR)) or scheduling request (SR). BS 102 may respond with a random access response (RAR) message (msgB) which may effectively combine MSG2 and MSG4 described above. For example, msgB may include the ID of the RACH preamble, a timing advance (TA), a back off indicator, a contention resolution message, UL/DL grant, and transmit power control (TPC) commands.

In a two-step RACH procedure, the msgA may include a RACH preamble and a payload. In some cases, the RACH preamble and payload may be sent in a msgA transmission occasion.

The random access message (msgA) transmission occasion generally includes a msgA preamble occasion (for transmitting a preamble signal) and a msgA payload occasion for transmitting a PUSCH. The msgA preamble transmission generally involves:
(1) selection of a preamble sequence; and
(2) selection of a preamble occasion in time/frequency domain (for transmitting the selected preamble sequence).
   The msgA payload transmission generally involves:
(1) construction of the random access message payload (DMRS/PUSCH); and
(2) selection of one or multiple PUSCH resource units (PRUs) in time/frequency domain to transmit this message (payload).

In some cases, a UE monitors SSB transmissions which are sent (by a gNB using different beams) and are associated with a finite set of time/frequency resources defining RACH occasions (ROs) and PRUs. Upon detecting an SSB, the UE may select an RO and one or more PRUs associated with that SSB for a MSG1/msgA transmission. In some cases, a RO associated with the detected SSB falls within a RedCap UE bandwidth, and the RedCap UE may utilize a separate initial UL BWP for RedCap (which is not expected to exceed the maximum RedCap UE bandwidth) which may include ROs for RedCap UEs. ROs may be dedicated for RedCap UEs or shared with non-RedCap UEs. The finite set of ROs and PRUs may help reduce monitoring overhead (blind decodes) by a base station.

There are several benefits to a two-step RACH procedure, such as speed of access and the ability to send a relatively small amount of data without the overhead of a full four-step RACH procedure to establish a connection (when the four-step RACH messages may be larger than the payload).

The two-step RACH procedure can operate in any RRC state and any supported cell size. Networks that uses two-step RACH procedures can typically support contention-based random access (CBRA) transmission of messages (e.g., msgA) within a finite range of payload sizes and with a finite number of MCS levels.

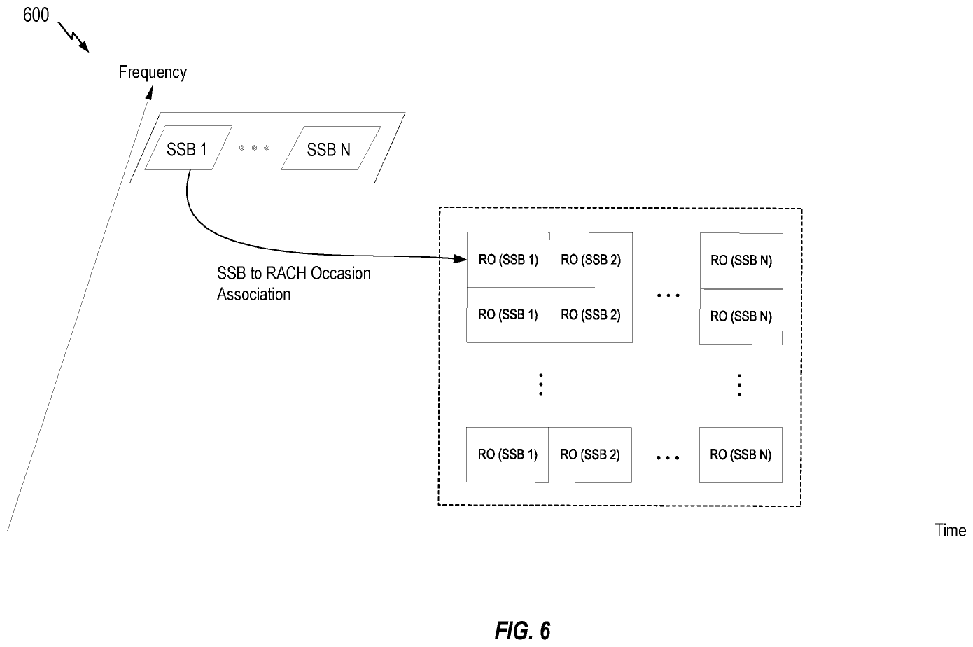

After a UE has selected an SSB (beam), for that SS block there is a predefined one or more ROs with certain time and frequency offset and direction (e.g., specific to the selected SSB). FIG. 6 illustrates an example association (mapping) between SSBs and ROs.

This SSB to RO association is used for the gNB to know what beam the UE has acquired/is using (generally referred to as beam establishment). One SSB may be associated with one or more ROs or more than one SSB may be associated with one RO. Association is typically performed in the frequency domain first, then in the time domain within a RACH slot, then in the time domain across RACH slots (e.g., beginning with lower SSB indexes). An association period is typically defined as a minimum number of RACH configuration periods, such that all (configured) SSB beams are mapped into ROs.

### Aspects Related to Switching from a RedCap BWP to Receive SSBs

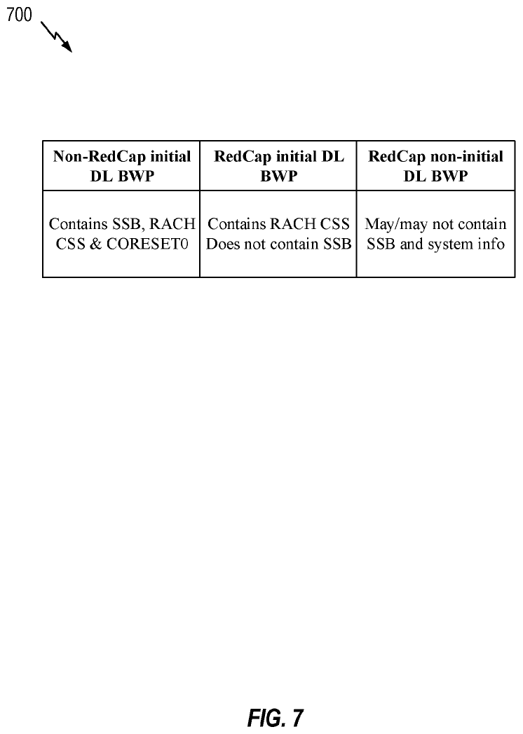

Due to differences in capability, RedCap UEs (due to their low bandwidth capability) and conventional (e.g., non-RedCap or Legacy) UEs may be configured to operate in bandwidth parts (BWPs) with different features. The table 700 in FIG. 7 summarizes some of the different features. For example, a conventional, non-RedCap initial downlink (DL) BWP may contain SSBs, RACH common search space (CSS) and CORESETO. As illustrated in FIG. 7, RedCap initial DL BWP may contain, for example, the RACH CSS, but may not contain SSBs, CORESETs (e.g., CORESETO, CORESET for paging), and/or system information blocks (SIB). In other cases, a RedCap UE may not contain the RACH CSS, but may contain CORESETs (e.g., CORESETO). Similarly, the RedCap non-initial DL BWP may not contain SSB or system information, and may be unable to access this information. Though operating without certain information may significantly reduce the complexity of a RedCap UE, a RedCap UE operating in these BWPs without access to information (e.g., SSBs) may not get the benefit of the information while operating on the BWP.

As a result, a RedCap UE operating in these BWPs may not get the benefit of SSBs. Aspects of the present disclosure, however, may allow a RedCap UE to implement an extended timelines, allowing the RedCap UE to switch to a different BWP (e.g., to a non-RedCap initial DL BWP) during a RACH procedure to monitor for SSBs. After detecting an SSB, the RedCap UE may then return (e.g., to the RedCap initial BWP) to resume the RACH procedure.

Thus, the techniques presented herein may help address a potential issue that is caused by the RedCap UE not being able to measure and track SSBs during a RACH procedure. The potential issue may be caused because, if the UE fails to receive a RAR after sending a RACH preamble and the UE is not allowed to monitor SSBs, the UE would have to re-select RACH resources using the same SSB during RACH retransmission (despite the previous failure). In certain cases, failure to track and measure SSBs in a RedCap BWP, may result in CORESET sets and CSS sets (e.g., for paging, small data transmission, random access, etc.) failing to be configured at a UE.

In some cases, the UE may be able to increase power ramping counter during RACH retransmission, but cannot change SSBs. This may lead to UE congestion during RACH retransmissions when, for example, other UEs may be reusing the same SSB for RACH transmission.

In general, a conventional RedCap UE is not be able to track SSBs from the time of an initial Msg1 transmission until the time the NW configures it with an active BWP (that contains non-cell-defining SSB) through RRC. As a result, a UE may not be able to receive and transmit messages properly during the RACH procedure.

### Overview of SDT Procedures

Small data transmission (SDT) procedures help avoid or reduce the signaling overhead (and delay) for a UE in an idle or inactive state to transition to a radio resource control (RRC) connected state just to receive or transmit a relatively small amount of data. Various SDT procedures may be based on a 2-step RACH procedure, a 4-step RACH procedure, or based on configured grants (CGs).

As illustrated in the call flow diagram 800 of FIG. 8, for a 2-step RACH based SDT procedure, a UE may transmit a (small amount of) uplink data in a msgA (combined RACH preamble and PUSCH payload) for mobile originated (MO SDT). The msgA may include an RRC resume request, the uplink data and, in some cases, a buffer status report (BSR) medium access control (MAC) control element (CE). In some cases, the network may include a small amount of data in a MsgB.

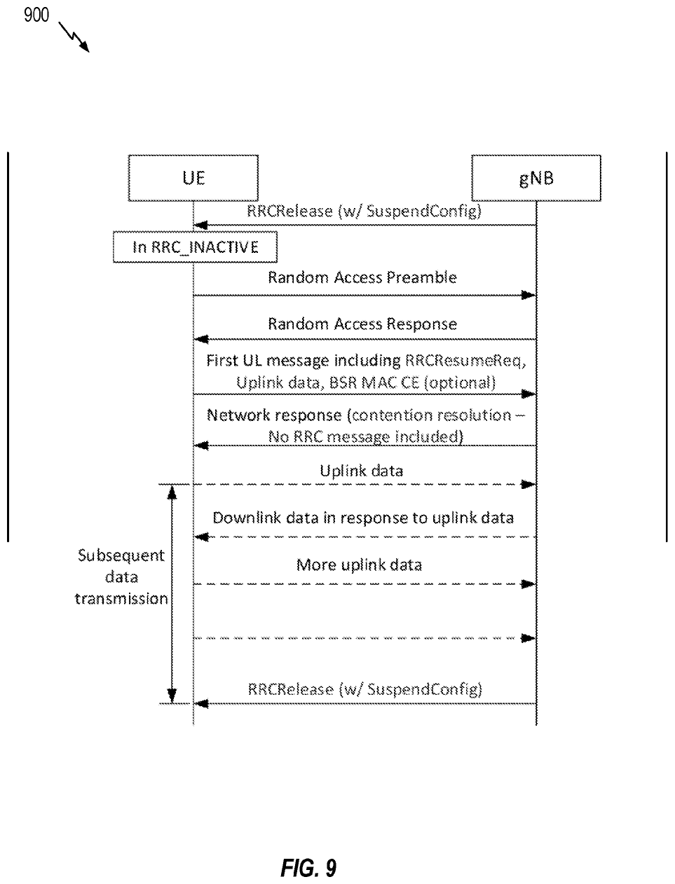

For a 4-step RACH based SDT procedure, as illustrated in the call flow diagram 900 of FIG. 9, the UE may transmit uplink data in a first uplink message after sending a RACH preamble. This first uplink message may include the RRC resume request, the uplink data and, in some cases, the BSR MAC CE.

In both the 2-step RACH based and 4-step RACH based procedures, in subsequent data transmissions (e.g., after a successful contention resolution), the UE may monitor dynamic grant (DG) by C-RNTI in a separate CSS (if configured) for random access based SDT (RA-SDT). An RRCRelease message may be sent at the end to terminate the SDT procedure from the RRC point of view.

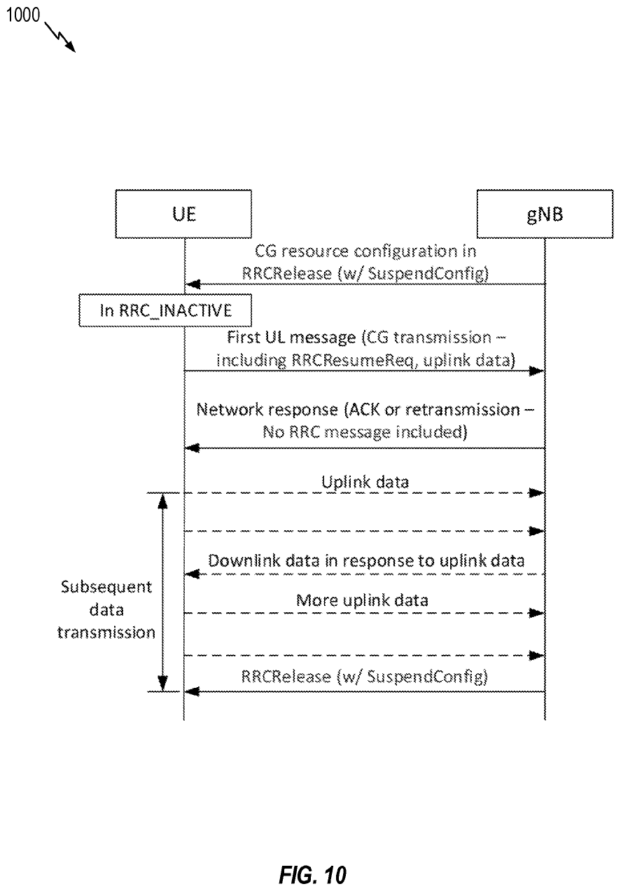

FIG. 10 depicts a call flow diagram for configured grant (CG) based SDT according to aspects of the present disclosure.

As illustrated, for CG-based SDT, a configuration of CG resources for UE uplink small data transfer may be contained in the RRCRelease message. The RRCRelease message may also be used to reconfigure or release the CG-SDT resources while UE is in RRC_INACTIVE.

The configuration of the CG resources may include one type 1 CG configuration (e.g., as opposed to type 2 CG configuration where activation via DCI is not needed). In some cases, multiple CG-SDT configurations per carrier in RRC_INACTIVE can be supported by network configuration. For CG-based SDT, the subsequent data transmission can use the CG resource for new data transmission or DG for retransmission.

### Aspects Related to Signaling SI Updates to Certain Types of UEs

Aspects of the present disclosure provide mechanisms for efficiently signaling SI updates to certain types of UEs, such as RedCap UEs or other type of UE that has different capabilities than another type of UE. As will be described in greater detail below, SI updates may be signaled via an SDT procedure (e.g., a 2-step, 4-step, or CG-based SDT procedure).

Certain examples described herein will refer to SI updates for idle/inactive RedCap UEs configured with DL BWPs (dedicated for RedCap UEs). More generally, the mechanisms described herein may be employed to deliver SI updates to various different types of UEs (in idle, inactive, or connected states). For example, the techniques may be employed to deliver SI updates to any type of UE that supports multicast and broadcast (MBS) capability in RRC connected state. While examples described herein also refer to configured initial DL BWPs and/or configured initial UL BWPs, the techniques more generally apply to scenarios where additional BWPs (e.g., second DL BWP and/or a second UL BWP) are configured for certain types of UEs (e.g., RedCap UEs) in addition to BWPs shared by UEs of different types (e.g., by RedCap and non RedCap UEs).

Similarly, while certain examples refer to an initial control resource set (CORESET #0), the techniques may apply to any type of common control resource set (e.g., common to UEs of a first type and a second type, such as RedCap UEs and non-RedCap UEs). For RACH, SDT and other procedures, UE to use both DL BWP and UL BWP, wherein the UL BWP is linked to the DL BWP and shares the same BWP ID. In some cases, a UE may perform RACH for on-demand SI request in idle, inactive or connected state.

According to certain aspects, the network may signal updated SI on a dedicated downlink BWP, so the UE may acquire the updated SI without switching to another BWP. In some cases, the network may provide an indication, via signaling on the dedicated downlink BWP, to notify the UE that there is updated SI available. In such cases, the UE may only switch to the other BWP to acquire the updated SI after receiving the notification. A network entity may transmit this indication of updated SI via unicast, multicast, groupcast (e.g., for sidelink), or broadcast signaling.

As noted above, a network may configure separate BWPs for RedCap UEs to perform certain functions, such as RACH procedures. In time division duplexed (TDD) and frequency division duplexed (FDD) scenarios, the network may or may not transmit SSBs in the RedCap-specific initial DL BWP. The network may or may not configure a common search space (CSS) for paging in the RedCap-specific initial DL BWP.

In such cases, if the RedCap-specific initial DL BWP does not contain CORESET #0, the RedCap UE may need to switch between CORESET #0 and the RedCap-specific initial DL BWP. Aspects of the present disclosure provide signaling support and UE procedures associated with paging, to allow a RedCap UE to receive updated SI, for example, when the RedCap UE is performing RACH or SDT on the RedCap-specific initial DL/UL BWP.

Certain aspects of the present disclosure may help reduce the latency and power consumption of UE to acquire modified SI. The techniques may be applicable, for example, when the UE is performing contention based random access (CBRA) or SDT (MO or MT) on a separately configured initial DL/UL BWP in TDD or FDD bands.

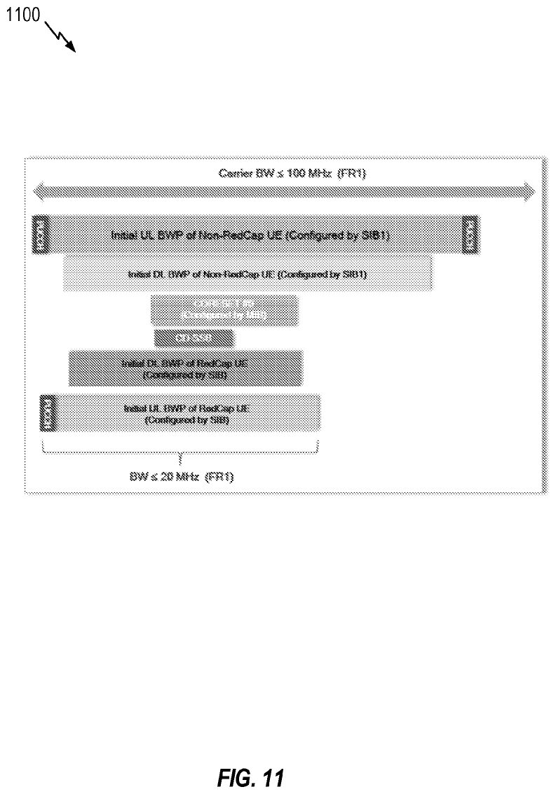

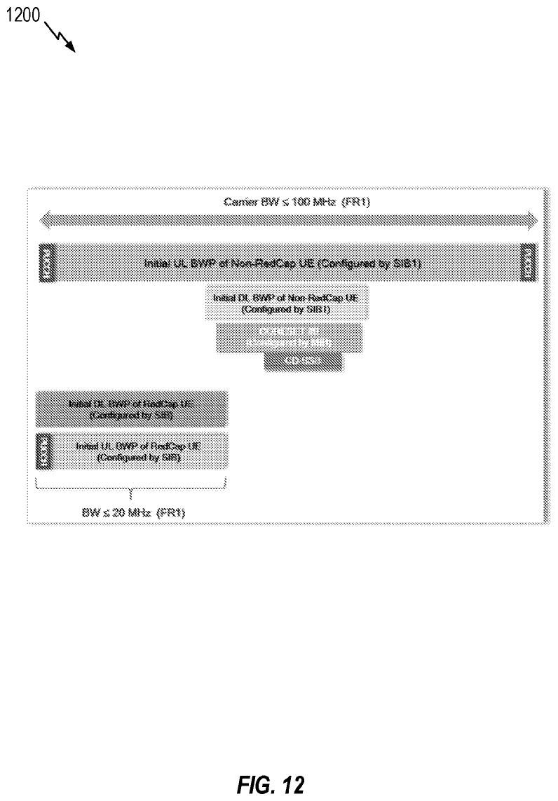

As illustrated in FIGS. 11 and 12, there are at least two general scenarios for separate initial BWP Configuration for RedCap UE. These different (initial) DL BWP configurations and different SDT types (MO/MT, RA-SDT/CG-SDT for MO) may lead to different signaling and UE procedures in obtaining the modified SI.

In the example of FIG. 11, an initial downlink BWP, cell defining (CD) SSBs may be transmitted and the CORESET #0 may be contained within the overall carrier bandwidth. As such, the UE may be able to measure the CD-SSB and may also monitor CORESET 0 without switching (re-tuning).

In the example of FIG. 12, the initial downlink BWP may not overlap and the CORESET #0 may be contained within the overall carrier bandwidth. Here, the initial DL BWP of RedCap UE (Configured by SIB) does not include the entire CORESET #0, but does includes CSS sets for paging, common search space and user-specific search space (CSS/USS) sets for SDT (MO and/or MT), and CSS/USS sets for multicast/broadcast.

Aspects of the present disclosure relate to signaling support and UE procedures associated with updating system information, when the RedCap UE is performing RACH or SDT on the RedCap-specific initial DL/UL BWP. This reduces the latency and power consumption of UE to acquire modified SI, when the UE is performing contention based random access (CBRA), SDT, or (MO or MT) on a separately configured initial DL/UL BWP in TDD or FDD bands.

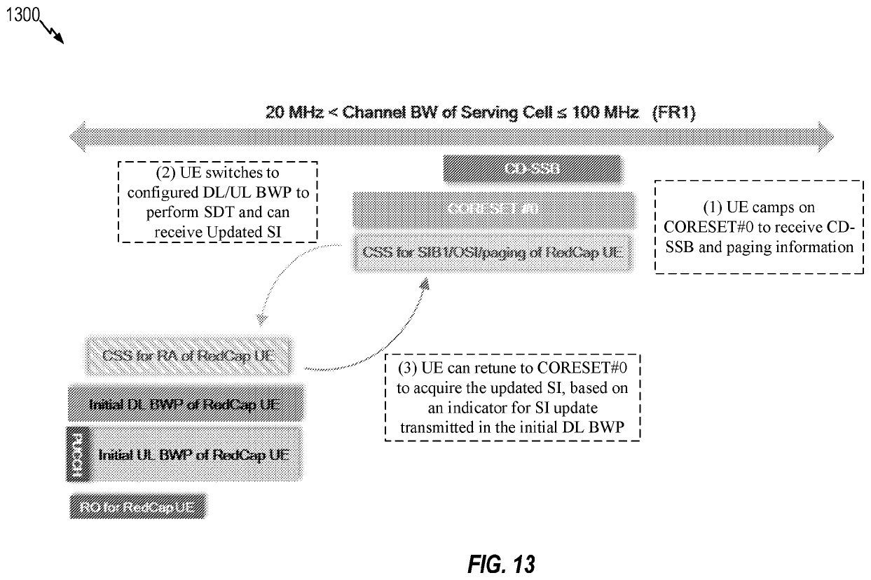

As illustrated in FIG. 13, when the initial DL BWP of RedCap UE (Configured by SIB) does not include the entire CORESET #0, but does includes CSS sets for paging, common search space and user-specific search space (CSS/USS) sets for SDT (MO and/or MT), and CSS/USS sets for multicast/broadcast.

Certain aspects of the present disclosure propose updated SI reception by a UE (e.g., RedCap or some other type) without paging. For example, if the separately configured initial DL BWP for RACH or SDT includes CSS sets for paging, the UE may be expected to receive modified SI via one of various options.

As noted in FIG. 13, when a RedCap UE in idle/inactive state is configured with a separate initial DL BWP without CORESET #0 for SDT or CBRA, the UE may camp on CORESET #0 to receive CD-SSB and paging information. In this case, the UE may also perform initial SI acquisition on CORESET #0. When UE needs to perform SDT or establish/resume RRC connection with the serving cell, the UE may switch to the separately configured initial DL/UL BWPs.

As will be described in greater detail below, according to some options, the UE can receive modified SI when performing SDT or CBRA on the separately configured initial DL BWP without retuning to CORESET #0. Alternatively, the UE may retune to CORESET #0 in order to acquire the modified SI, for example, based on an indicator for SI update transmitted in the initial DL BWP.

Aspects of the present disclosure may allow for the delivery of updated SI in a configured downlink BWP without paging. For example, a UE in idle/inactive state can perform RACH or SDT (MO-SDT or MT-SDT) on a separately configured initial DL BWP without CORESET #0. If the separately configured initial DL BWP does not include CSS sets for paging or SI deliver, the UE may be expected to receive updated SI via one of various options.

According to a first option, the UE may receive modified SI via an RRC Reconfiguration message. The RRC Reconfiguration message may be scheduled by a unicast PDCCH in USS/CSS of the initial DL BWP. This PDCCH may be transmitted to UE after contention resolution is completed for CBRA or RA-based SDT.

According to a second option, the UE may receive modified SI via an RRC Release message with a Suspend Configuration. This RRC Release message may be scheduled by a unicast PDCCH in USS/CSS of the initial DL BWP. This PDCCH may be transmitted after contention resolution is completed in an RA-based SDT, or after the gNB has received the initial CG-SDT message carrying CCCH of UE.

According to a third option, the UE may receive modified SI via a mobile terminated small data transmission (MT-SDT) message scheduled by a unicast PDCCH in USS/CSS of the initial DL BWP. This PDCCH may be transmitted after contention resolution is completed in RA-based SDT, or after gNB has received the initial CG-SDT message carrying CCCH of UE.

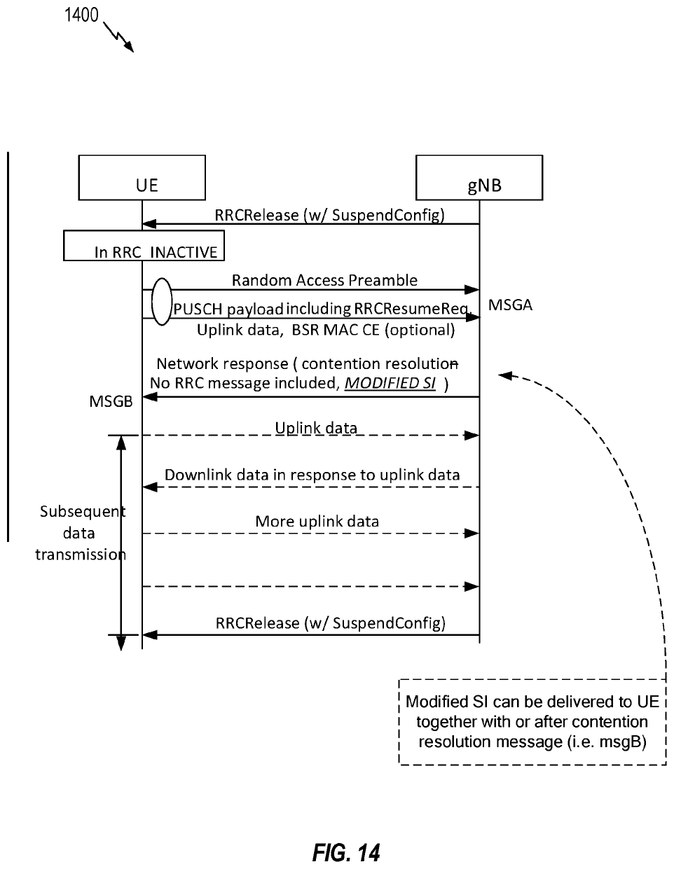

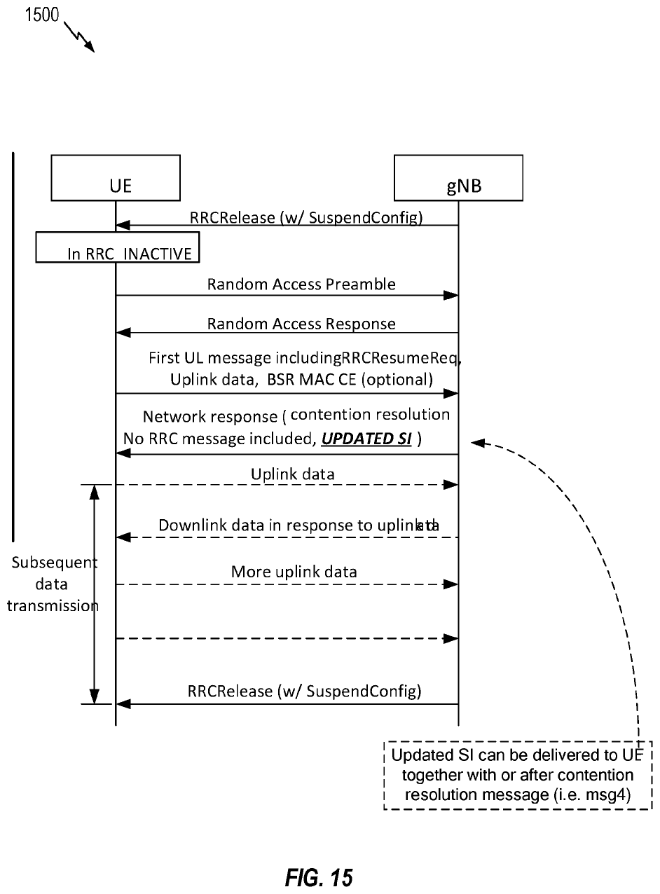

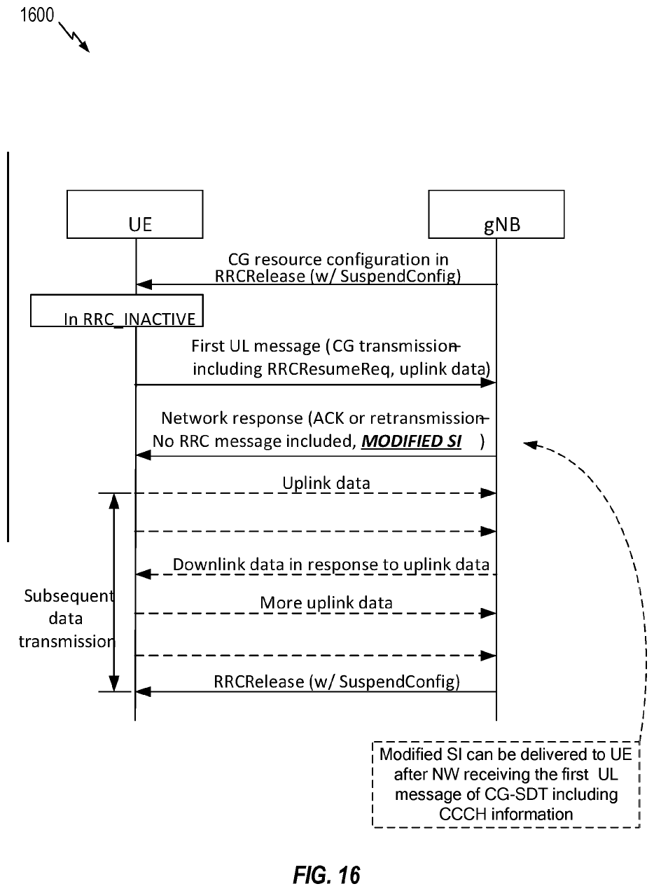

As illustrated in FIG. 14, for a 2-step RA-SDT, updated SI may be delivered to the UE together with or after contention resolution message (e.g., msgB). As illustrated in FIG. 15, for a 4-step RA-SDT, the updated SI may be delivered to the UE together with or after contention resolution message (e.g., msg4). As illustrated in FIG. 16, for a CG-SDT, the updated SI may be delivered to the UE after the network receives the first UL message of CG-SDT including CCCH information.

According to a fourth option, the UE may receive modified SI via a multicast or broadcast PDSCH transmitted in the initial DL BWP. According to this option, the PDSCH may be scheduled by a group-common PDCCH in CSS of the initial DL BWP, or triggered by a MAC CE carried by a random access response (RAR), a contention resolution message of CBRA, RA-based SDT, or triggered by a bit field in the scheduling DCI of RAR, or a contention resolution message of CBRA or RA-based SDT.

According to a fifth option, the UE may be notified of (the existence of) updated SI via an indicator (non-paging signaling) notifying the UE about the SI modification. This notification may indicate any type of SI modification, including updated public warning system (PWS), Earthquake and Tsunami Warning System (ETWS), or Commercial Mobile Alert System (CMAS) information. Such a notification of updated SI may indicate SI transmitted in the first DL BWP has changed, may indicate PWS notification (e.g. ETWS, CMAS and etc.), or may indicate a response to a UE's request for on-demand SI delivery.

Receipt of this notification may trigger the UE to retune (perform BWP switching) to CORESET #0 for SI acquisition. In some cases, the indication may be mapped to downlink reference signals (DL RS) and/or physical channels, such as non cell defining SSBs (NCD-SSB), resync signals, wake up signals (WUS), paging early indicator (PEI), demodulation reference signals (DMRS), physical downlink control channel (PDCCH), or physical downlink shared channel (PDSCH) transmitted in the initial DL BWP.

Aspects of the present disclosure may allow for the delivery of updated SI with paging. For example, of the separately configured initial DL BWP for RACH or SDT includes CSS sets for paging, the UE may expect to receive updated SI according to various options.

According to a first option, the UE may receive updated SI via a short message transmitted on a paging occasion (PO) of the separately configured initial DL BWP. This short message may trigger the UE to retune to CORESET #0 to acquire modified SI (e.g., if CSS sets for SI are not configured on the initial DL BWP). In some cases, the UE may send an implicit or explicit request for a paging message restriction or coverage enhancement for paging PDCCH. This request may be sent, for example, via a physical random access channel (PRACH), physical uplink shared channel (PUSCH), physical uplink control channel (PUCCH), or uplink control information (UCI) multiplexed with PUSCH.

According to a second option, the UE may receive updated SI via a short message transmitted on a PO configured on the initial DL BWP, which notifies the UE to receive the updated SI transmitted in the initial DL BWP. In this case, the UE receives the updated SI without retuning to CORESET #0 (e.g., if CSS sets for SI are configured on the initial DL BWP). In some cases, the UE can send an implicit or explicit request for a paging message restriction or coverage enhancement for paging PDCCH (e.g., via PRACH, PUSCH, PUCCH, or UCI multiplexed with PUSCH).

According to a third option, upon receiving a short message transmitted on a PO configured on the initial DL BWP, the UE can send a request (e.g., via PRACH/PUSCH/PUCCH/UCI multiplexed with PUSCH) to trigger on-demand delivery of updated SI within the separately configured initial DL BWP. In some cases, the UE may start a timer after sending the request and monitors for the network response for “on-demand delivery of modified SI” until the timer expires. If the NW receives the UE request before the timer expires, the updated SI can be delivered to the UE by unicast, multicast, or broadcast signaling. The scheduling PDCCH of the modified SI may be scrambled by a group radio network temporary identifier (RNTI) or an RNTI associated with a UE ID and the UL resource index used for requesting the on-demand delivery of modified SI.

As described herein, which option is used to deliver updated SI to a UE may depend on how a downlink BWP (e.g., an initial downlink bandwidth part dedicated for RedCap UEs) is configured.

For example, if the downlink BWP includes the entire CORESET #0 and CD-SSB are transmitted, includes CSS sets for paging/SI, CSS/USS sets for SDT (MO and/or MT), and CSS/USS sets for multicast/broadcast, the UE may receive updated SI according to the second and third options for receiving updated SI via paging, described above. On the other hand, if the downlink BWP does not include the entire CORESET #0 and CD-SSB and does not include the CSS for SI, but does include CSS sets for paging, CSS/USS sets for SDT (MO and/or MT), and CSS/USS sets for multicast/broadcast, the UE may receive updated SI according to the first, second and third options for receiving updated SI without paging, described above.

In some cases, there may be a restriction on CG-SDT configurations that limits when updated SI can be delivered via this mechanism. For example, if the separately configured initial DL BWP includes CSS/USS sets for CG-SDT, the UE may be expected to receive DL RS suitable for timing advance (TA) validation, spatial relation configuration, CG-SDT occasion validation, and radio resource management (RRM) in the initial DL BWP. In such cases, the DL RS may include CD-SSB or NCD-SSB, tracking reference signals (TRS), resync signals, wakeup signals (WUS), or paging early indication (PEI). The restriction may be such that if the separately configured initial DL BWP does not include DL RS applicable for these purposes (e.g., TA validation, spatial relation configuration, CG-SDT occasion validation, and RRM), the UE may not be expected to perform CG-SDT in the separately configured initial DL BWP.

### Example Methods

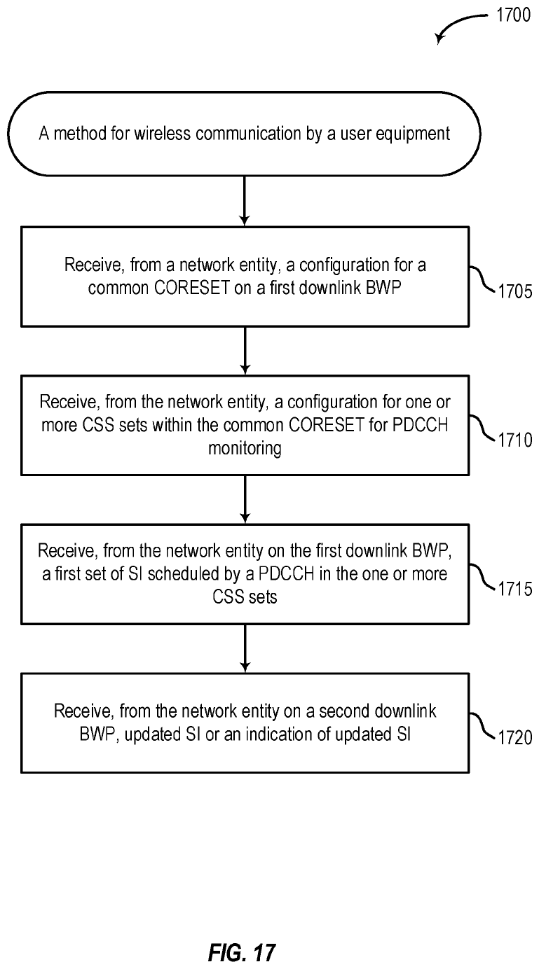

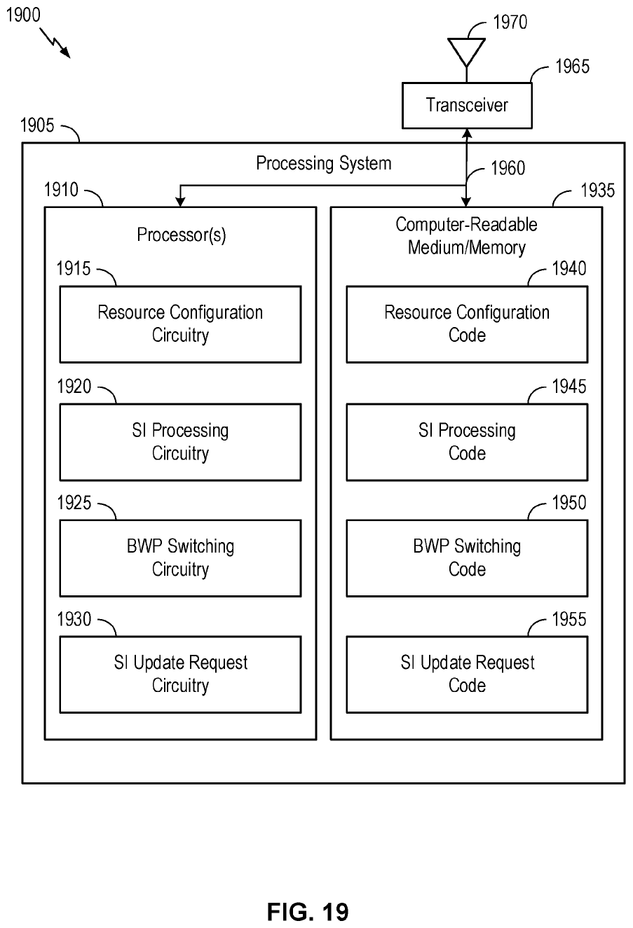

FIG. 17 shows an example of a method 1700 for wireless communication according to aspects of the present disclosure. In some aspects, a user equipment, such as UE 104 of FIGS. 1 and 2, or processing system 1905 of FIG. 19, may perform the method 1700.

Method 1700 begins at step 1705 with receiving, from a network entity, a configuration for a common CORESET on a first downlink BWP. In some cases, the operations of this step refer to, or may be performed by, resource configuration circuitry as described with reference to FIG. 19.

Method 1700 then proceeds to step 1710 with receiving, from the network entity, a configuration for one or more CSS sets within the common CORESET for PDCCH monitoring. In some cases, the operations of this step refer to, or may be performed by, resource configuration circuitry as described with reference to FIG. 19.

Method 1700 then proceeds to step 1715 with receiving, from the network entity on the first downlink BWP, a first set of SI scheduled by a PDCCH in the one or more CSS sets. In some cases, the operations of this step refer to, or may be performed by, SI processing circuitry as described with reference to FIG. 19.

Method 1700 then proceeds to step 1720 with receiving, from the network entity on a second downlink BWP, updated SI or an indication of updated SI. In some cases, the operations of this step refer to, or may be performed by, SI processing circuitry as described with reference to FIG. 19.

In some aspects, the UE is a UE of a first type having a first set of capabilities. In some aspects, the common CORESET and the one or more CSS sets are configured for common use by UEs of the first type and UEs of a second type having a second set of capabilities. In some aspects, the second downlink BWP is configured for dedicated use by UEs of the first type in an idle state, an inactive state, or a connected state.

In some aspects, receiving the updated SI or the indication of updated SI comprises at least one of: receiving an indication that the first set of SI has changed, receiving a notification for updated PWS information, or receiving a response to a request by the UE for on-demand SI delivery or a combination thereof.

In some aspects, the method 1700 further includes monitoring one or more search space sets associated with unicast, multicast, groupcast, or broadcast signaling to receive at least one of the updated SI or the indication of updated SI.

In some aspects, the method 1700 further includes receiving SSBs and paging information on the first downlink BWP. In some aspects, the method 1700 further includes performing at least one of a RACH procedure, a MO data transmission, or a MT data reception procedure using the second downlink BWP and an uplink BWP linked to the second downlink BWP while the UE is in the idle state, the inactive state, or the connected state.

In some aspects, receiving the updated SI or the indication of updated SI comprises obtaining scheduling information for at least one RRC message and receiving the at least one RRC message based on the scheduling information. In some aspects, the indication of updated SI or the updated SI is included in at least one of the scheduling information or the RRC message.

In some aspects, the RRC message comprises at least one of: an RRC connection reconfiguration message, an RRC connection setup message, an RRC release message, a contention resolution message, or a random access response message.

In some aspects, receiving the updated SI or the indication of updated SI comprises: obtaining scheduling information for a MT data transmission and receiving the MT data transmission based on the scheduling information, wherein the indication of updated SI or the updated SI are included in the scheduling information, the MT data, or a combination thereof.

In some aspects, receiving the updated SI or the indication of updated SI comprises: monitoring one or more search space sets associated with at least one of unicast, multicast, or groupcast signaling; receiving a unicast, multicast, groupcast or broadcast PDSCH based on scheduling information transmitted in the one or more search space sets; and obtaining the indication of updated SI or the updated SI by decoding the PDSCH and its scheduling information.

In some aspects, the method 1700 further includes, after receiving the indication of updated SI from the network entity on the second downlink BWP, switching to the first downlink BWP to receive the updated SI.

In some aspects, the indication of updated SI is received via a downlink reference signal or a downlink physical channel received in the second downlink BWP via at least one of unicast, multicast, groupcast, or broadcast signaling.

In some aspects, the second downlink BWP has one or more CSS sets configured for at least one of paging, PEI, or WUS. In some aspects, receiving the updated SI or the indication of updated SI comprises receiving the indication of updated SI in a PDCCH monitoring occasion configured for the one or more CSS sets.

In some aspects, the method 1700 further includes, after receiving the indication of updated SI in the PDCCH monitoring occasion, switching to the first downlink BWP to receive the updated SI.

In some aspects, receiving the indication of updated SI comprises: receiving a short message transmitted in (i) a PDCCH in the PDCCH monitoring occasion or (ii) a PDSCH scheduled by a PDCCH in the PDCCH monitoring occasion.

In some aspects, the method 1700 further includes transmitting, to the network entity, a request for delivery of the updated SI or a restricted set of updated SI related to UEs of the first type in the second downlink BWP.

In some aspects, transmitting the request comprises transmitting the request via at least one of: a PRACH, a PUSCH, a PUCCH, UCI multiplexed with PUSCH, a reference signal, or a preamble.

In some aspects, the method 1700 further includes starting a timer after transmitting the request for delivery of the updated SI in the second downlink BWP. In some aspects, the method 1700 further includes monitoring for a response from the network entity to the request for delivery of the updated SI in the second downlink BWP until the timer expires.

In some aspects, the method 1700 further includes receiving signaling for configuring the UE to perform a CG based MO data transmission procedure or a paging triggered MT data reception on the second downlink BWP while the UE is in the idle state or the inactive state.

In some aspects, the UE receives one or more RSs suitable for at least one of: TA validation, spatial relation configuration, MO data transmission occasion validation, QCL configuration, measurements, synchronization, positioning, ranging, channel sensing, radio resource allocation, or RRM in the second downlink BWP.

In one aspect, method 1700, or any aspect related to it, may be performed by an apparatus, such as communications device 1900 of FIG. 19, which includes various components operable, configured, or adapted to perform the method 1700. Communications device 1900 is described below in further detail.

Note that FIG. 17 is just one example of a method, and other methods including fewer, additional, or alternative steps are possible consistent with this disclosure.

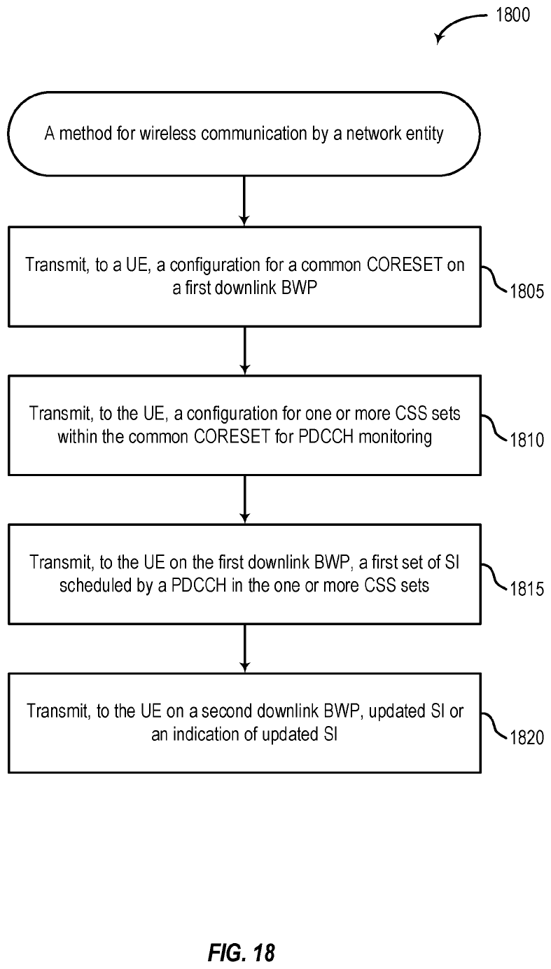

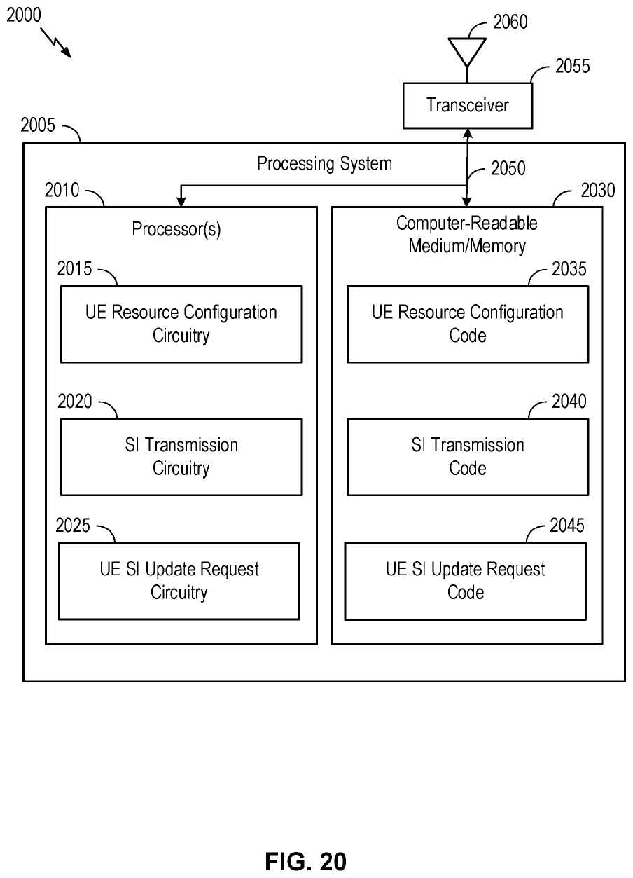

FIG. 18 shows an example of a method 1800 for wireless communication according to aspects of the present disclosure. In some aspects, a base station, such as BS 102 of FIGS. 1 and 2, or processing system 2005 of FIG. 20, may perform the method 1800.

Method 1800 begins at step 1805 with transmitting, to a UE, a configuration for a common CORESET on a first downlink BWP. In some cases, the operations of this step refer to, or may be performed by, UE resource configuration circuitry as described with reference to FIG. 20.

Method 1800 then proceeds to step 1810 with transmitting, to the UE, a configuration for one or more CSS sets within the common CORESET for PDCCH monitoring. In some cases, the operations of this step refer to, or may be performed by, UE resource configuration circuitry as described with reference to FIG. 20.

Method 1800 then proceeds to step 1815 with transmitting, to the UE on the first downlink BWP, a first set of SI scheduled by a PDCCH in the one or more CSS sets. In some cases, the operations of this step refer to, or may be performed by, SI transmission circuitry as described with reference to FIG. 20.

Method 1800 then proceeds to step 1820 with transmitting, to the UE on a second downlink BWP, updated SI or an indication of updated SI. In some cases, the operations of this step refer to, or may be performed by, SI transmission circuitry as described with reference to FIG. 20.

In some aspects, the UE is a UE of a first type having a first set of capabilities. In some aspects, the common CORESET and the one or more CSS sets are configured for common use by UEs of the first type and UEs of a second type having a second set of capabilities. In some aspects, the second downlink BWP is configured for dedicated use by UEs of the first type in an idle state, an inactive state, or a connected state.

In some aspects, transmitting the updated SI or the indication of updated SI comprises at least one of: transmitting an indication that the first set of SI has changed, transmitting a notification for updated PWS information, or transmitting a response to a request by the UE for on-demand SI delivery or a combination thereof.

In some aspects, the updated SI or the indication of updated SI is transmitted in one or more search space sets associated with unicast, multicast, groupcast, or broadcast signaling.

In some aspects, the method 1800 further includes transmitting SSBs and paging information on the first downlink BWP. In some aspects, the method 1800 further includes participating with the UE in at least one of a RACH procedure, a MO data reception, or a MT data transmission procedure using the second downlink BWP and an uplink BWP linked to the second downlink BWP while the UE is in the idle state, the inactive state, or the connected state.

In some aspects, transmitting the updated SI or the indication of updated SI comprises transmitting scheduling information for at least one RRC message and receiving the at least one RRC message based on the scheduling information. In some aspects, the indication of updated SI or the updated SI is included in at least one of the scheduling information or the RRC message.

In some aspects, the RRC message comprises at least one of: an RRC connection reconfiguration message, an RRC connection setup message, an RRC release message, a contention resolution message, or a random access response message.

In some aspects, transmitting the updated SI or the indication of updated SI comprises: transmitting scheduling information for a MT data transmission and transmitting the MT data transmission based on the scheduling information, wherein the indication of updated SI or the updated SI are included in the scheduling information, the MT data, or a combination thereof.

In some aspects, transmitting the updated SI or the indication of updated SI comprises: transmitting scheduling information in one or more search space sets associated with at least one of unicast, multicast, or groupcast signaling; and transmitting a unicast, multicast, groupcast or broadcast PDSCH in accordance with the scheduling information, wherein at least one of the PDSCH or the scheduling information includes the indication of updated SI or the updated SI.

In some aspects, the method 1800 further includes, after transmitting the indication of updated SI to the UE on the second downlink BWP, transmitting the updated SI to the UE on the first downlink BWP.

In some aspects, the indication of updated SI is transmitted via a downlink reference signal or a downlink physical channel received in the second downlink BWP via at least one of unicast, multicast, groupcast, or broadcast signaling.

In some aspects, the second downlink BWP has one or more CSS sets configured for at least one of paging, PEI, or WUS. In some aspects, transmitting the updated SI or the indication of updated SI comprises transmitting the indication of updated SI in a PDCCH monitoring occasion configured for the one or more CSS sets.

In some aspects, the method 1800 further includes, after transmitting the indication of updated SI in the PDCCH monitoring occasion, transmitting the updated SI in the first downlink BWP.

In some aspects, transmitting the indication of updated SI comprises: transmitting a short message in (i) a PDCCH in the PDCCH monitoring occasion or (ii) a PDSCH scheduled by a PDCCH in the PDCCH monitoring occasion.

In some aspects, the method 1800 further includes receiving, from the UE, a request for delivery of the updated SI or a restricted set of updated SI related to UEs of the first type in the second downlink BWP.

In some aspects, receiving the request comprises receiving the request via at least one of: a PRACH, a PUSCH, a PUCCH, UCI multiplexed with PUSCH, a reference signal, or a preamble.

In some aspects, the method 1800 further includes starting a timer after receiving the request for delivery of the updated SI in the second downlink BWP. In some aspects, the method 1800 further includes transmitting the response to the request for delivery of the updated SI in the second downlink BWP before the timer expires.

In some aspects, the method 1800 further includes transmitting signaling for configuring the UE to perform a CG based MO data transmission procedure or a paging triggered MT data reception on the second downlink BWP while the UE is in the idle state or the inactive state.

In some aspects, the network entity transmits one or more RSs suitable for at least one of: TA validation, spatial relation configuration, MO data transmission occasion validation, QCL configuration, measurements, synchronization, positioning, ranging, channel sensing, radio resource allocation or RRM in the second downlink BWP.

In one aspect, method 1800, or any aspect related to it, may be performed by an apparatus, such as communications device 2000 of FIG. 20, which includes various components operable, configured, or adapted to perform the method 1800. Communications device 2000 is described below in further detail.

Note that FIG. 18 is just one example of a method, and other methods including fewer, additional, or alternative steps are possible consistent with this disclosure.

### Example Wireless Communication Device

FIG. 19 depicts an example communications device 1900 that includes various components operable, configured, or adapted to perform operations for the techniques disclosed herein, such as the operations depicted and described with respect to FIG. 17. In some examples, communication device 1900 may be a UE 104 as described, for example with respect to FIGS. 1 and 2.

Communications device 1900 includes a processing system 1905 coupled to the transceiver 1965 (e.g., a transmitter and/or a receiver). The transceiver 1965 is configured to transmit (or send) and receive signals for the communications device 1900 via the antenna 1970, such as the various signals as described herein. The transceiver 1965 may communicate bi-directionally, via the antennas 1970, wired links, or wireless links as described herein. For example, the transceiver 1965 may represent a wireless transceiver and may communicate bi-directionally with another wireless transceiver. The transceiver 1965 may also include or be connected to a modem to modulate the packets and provide the modulated packets to for transmission, and to demodulate received packets. In some examples, the transceiver 1965 may be tuned to operate at specified frequencies. For example, a modem can configure the transceiver 1965 to operate at a specified frequency and power level based on the communication protocol used by the modem.

Processing system 1905 may be configured to perform processing functions for communications device 1900, including processing signals received and/or to be transmitted by communications device 1900. Processing system 1905 includes one or more processors 1910 coupled to a computer-readable medium/memory 1935 via a bus 1960.

In some examples, one or more processors 1910 may include one or more intelligent hardware devices, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the one or more processors 1910 are configured to operate a memory array using a memory controller. In other cases, a memory controller is integrated into the one or more processors 1910. In some cases, the one or more processors 1910 are configured to execute computer-readable instructions stored in a memory to perform various functions. In some aspects, one or more processors 1910 include special purpose components for modem processing, baseband processing, digital signal processing, or transmission processing.

In certain aspects, computer-readable medium/memory 1935 is configured to store instructions (e.g., computer-executable code) that when executed by the one or more processors 1910, cause the one or more processors 1910 to perform the operations illustrated in FIG. 17, or other operations for performing the various techniques discussed herein.

In one aspect, computer-readable medium/memory 1935 includes resource configuration code 1940, SI processing code 1945, BWP switching code 1950, and SI update request code 1955.

Examples of a computer-readable medium/memory 1935 include random access memory (RAM), read-only memory (ROM), solid state memory, a hard drive, a hard disk drive, etc. In some examples, computer-readable medium/memory 1935 is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 1900 may provide means for performing the methods described herein, including with respect to FIG. 17.

In some examples, means for transmitting or sending (or means for outputting for transmission) may include transceivers 254 and/or antenna(s) 252 of the UE 104 illustrated in FIG. 2 and/or the transceiver 1965 and the antenna 1970 of the communication device in FIG. 19.

In some examples, means for receiving (or means for obtaining) may include transceivers 254 and/or antenna(s) 252 of the UE 104 illustrated in FIG. 2 and/or the transceiver 1965 and the antenna 1970 of the communication device in FIG. 19.

In some examples, means for receiving may include various processing system 1905 components, such as: the one or more processors 1910 in FIG. 19, or aspects of the UE 104 depicted in FIG. 2, including receive processor 258, transmit processor 264, TX MIMO processor 266, and/or controller/processor 280 (including SI processing component 281).

In one aspect, one or more processors 1910 includes resource configuration circuitry 1915, SI processing circuitry 1920, BWP switching circuitry 1925, and SI update request circuitry 1930.

According to some aspects, resource configuration circuitry 1915 receives, from a network entity, a configuration for a common CORESET on a first downlink BWP. In some examples, resource configuration circuitry 1915 receives, from the network entity, a configuration for one or more CSS sets within the common CORESET for PDCCH monitoring.

According to some aspects, SI processing circuitry 1920 receives, from the network entity on the first downlink BWP, a first set of SI scheduled by a PDCCH in the one or more CSS sets. In some examples, SI processing circuitry 1920 receives, from the network entity on a second downlink BWP, updated SI or an indication of updated SI.

In some aspects, the UE is a UE of a first type having a first set of capabilities. In some aspects, the common CORESET and the one or more CSS sets are configured for common use by UEs of the first type and UEs of a second type having a second set of capabilities. In some aspects, the second downlink BWP is configured for dedicated use by UEs of the first type in an idle state, an inactive state, or a connected state. In some aspects, receiving the updated SI or the indication of updated SI comprises at least one of: receiving an indication that the first set of SI has changed, receiving a notification for updated PWS information, or receiving a response to a request by the UE for on-demand SI delivery or a combination thereof.

In some examples, SI processing circuitry 1920 monitors one or more search space sets associated with unicast, multicast, groupcast, or broadcast signaling to receive at least one of the updated SI or the indication of updated SI. In some examples, SI processing circuitry 1920 receives SSBs and paging information on the first downlink BWP. In some examples, SI processing circuitry 1920 performs at least one of a RACH procedure, a MO data transmission, or a MT data reception procedure using the second downlink BWP and an uplink BWP linked to the second downlink BWP while the UE is in the idle state, the inactive state, or the connected state.

In some aspects, receiving the updated SI or the indication of updated SI comprises obtaining scheduling information for at least one RRC message and receiving the at least one RRC message based on the scheduling information. In some aspects, the indication of updated SI or the updated SI is included in at least one of the scheduling information or the RRC message. In some aspects, the RRC message comprises at least one of: an RRC connection reconfiguration message, an RRC connection setup message, an RRC release message, a contention resolution message, or a random access response message.

In some aspects, receiving the updated SI or the indication of updated SI comprises obtaining scheduling information for a MT data transmission and receiving the MT data transmission based on the scheduling information, wherein the indication of updated SI or the updated SI are included in the scheduling information, the MT data, or a combination thereof. In some aspects, receiving the updated SI or the indication of updated SI comprises: monitoring one or more search space sets associated with at least one of unicast, multicast, or groupcast signaling; receiving a unicast, multicast, groupcast or broadcast PDSCH based on scheduling information transmitted in the one or more search space sets; and obtaining the indication of updated SI or the updated SI by decoding the PDSCH and its scheduling information.

According to some aspects, after receiving the indication of updated SI from the network entity on the second downlink BWP, BWP switching circuitry 1925 switches to the first downlink BWP to receive the updated SI. In some aspects, the indication of updated SI is received via a downlink reference signal or a downlink physical channel received in the second downlink BWP via at least one of unicast, multicast, groupcast, or broadcast signaling. In some aspects, the second downlink BWP has one or more CSS sets configured for at least one of paging, PEI, or WUS. In some aspects, receiving the updated SI or the indication of updated SI comprises receiving the indication of updated SI in a PDCCH monitoring occasion configured for the one or more CSS sets. In some examples, after receiving the indication of updated SI in the PDCCH monitoring occasion, BWP switching circuitry 1925 switches to the first downlink BWP to receive the updated SI. In some aspects, receiving the indication of updated SI comprises: receiving a short message transmitted in (i) a PDCCH in the PDCCH monitoring occasion or (ii) a PDSCH scheduled by a PDCCH in the PDCCH monitoring occasion.

According to some aspects, SI update request circuitry 1930 transmits, to the network entity, a request for delivery of the updated SI or a restricted set of updated SI related to UEs of the first type in the second downlink BWP. In some aspects, transmitting the request comprises transmitting the request via at least one of: a PRACH, a PUSCH, a PUCCH, UCI multiplexed with PUSCH, a reference signal, or a preamble. In some examples, SI update request circuitry 1930 starts a timer after transmitting the request for delivery of the updated SI in the second downlink BWP. In some examples, SI update request circuitry 1930 monitors for a response from the network entity to the request for delivery of the updated SI in the second downlink BWP until the timer expires.

In some examples, resource configuration circuitry 1915 receives signaling for configuring the UE to perform a CG based MO data transmission procedure or a paging triggered MT data reception on the second downlink BWP while the UE is in the idle state or the inactive state. In some aspects, the UE receives one or more RSs suitable for at least one of: TA validation, spatial relation configuration, MO data transmission occasion validation, QCL configuration, measurements, synchronization, positioning, ranging, channel sensing, radio resource allocation, or RRM in the second downlink BWP.

Notably, FIG. 19 is just one example, and many other examples and configurations of communication device are possible.

FIG. 20 depicts an example communications device 2000 that includes various components operable, configured, or adapted to perform operations for the techniques disclosed herein, such as the operations depicted and described with respect to FIG. 18. In some examples, communication device may be a BS 102 as described, for example with respect to FIGS. 1 and 2.

Communications device 2000 includes a processing system 2005 coupled to the transceiver 2055 (e.g., a transmitter and/or a receiver). The transceiver 2055 is configured to transmit (or send) and receive signals for the communications device 2000 via the antenna 2060, such as the various signals as described herein. The transceiver 2055 may communicate bi-directionally, via the antennas 2060, wired links, or wireless links as described herein. For example, the transceiver 2055 may represent a wireless transceiver and may communicate bi-directionally with another wireless transceiver. The transceiver 2055 may also include or be connected to a modem to modulate the packets and provide the modulated packets to for transmission, and to demodulate received packets. In some examples, the transceiver 2055 may be tuned to operate at specified frequencies. For example, a modem can configure the transceiver 2055 to operate at a specified frequency and power level based on the communication protocol used by the modem.

Processing system 2005 may be configured to perform processing functions for communications device 2000, including processing signals received and/or to be transmitted by communications device 2000. Processing system 2005 includes one or more processors 2010 coupled to a computer-readable medium/memory 2030 via a bus 2050.

In some examples, one or more processors 2010 may include one or more intelligent hardware devices, (e.g., a general-purpose processing component, a DSP, a CPU, a GPU, a microcontroller, an ASIC, a FPGA, a programmable logic device, a discrete gate or transistor logic component, a discrete hardware component, or any combination thereof). In some cases, the one or more processors 2010 are configured to operate a memory array using a memory controller. In other cases, a memory controller is integrated into the one or more processors 2010. In some cases, the one or more processors 2010 are configured to execute computer-readable instructions stored in a memory to perform various functions. In some aspects, one or more processors 2010 include special purpose components for modem processing, baseband processing, digital signal processing, or transmission processing.

In certain aspects, computer-readable medium/memory 2030 is configured to store instructions (e.g., computer-executable code) that when executed by the one or more processors 2010, cause the one or more processors 2010 to perform the operations illustrated in FIG. 18, or other operations for performing the various techniques discussed herein.

In one aspect, computer-readable medium/memory 2030 includes UE resource configuration code 2035, SI transmission code 2040, and UE SI update request code 2045.

Examples of a computer-readable medium/memory 2030 include RAM, ROM, solid state memory, a hard drive, a hard disk drive, etc. In some examples, computer-readable medium/memory 2030 is used to store computer-readable, computer-executable software including instructions that, when executed, cause a processor to perform various functions described herein. In some cases, the memory contains, among other things, a BIOS which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

Various components of communications device 2000 may provide means for performing the methods described herein, including with respect to FIG. 18.

In some examples, means for transmitting or sending (or means for outputting for transmission) may include transceivers 232 and/or antenna(s) 234 of the BS 102 illustrated in FIG. 2 and/or the transceiver 2055 and the antenna 2060 of the communication device in FIG. 20.

In some examples, means for receiving (or means for obtaining) may include transceivers 232 and/or antenna(s) 234 of the BS 102 illustrated in FIG. 2 and/or the transceiver 2055 and the antenna 2060 of the communication device in FIG. 20.

In some examples, means for transmitting may include various processing system 2005 components, such as: the one or more processors 2010 in FIG. 20, or aspects of the BS 102 depicted in FIG. 2, including receive processor 238, transmit processor 220, TX MIMO processor 230, and/or controller/processor 240 (including SI processing component 241).

In one aspect, one or more processors 2010 includes UE resource configuration circuitry 2015, SI transmission circuitry 2020, and UE SI update request circuitry 2025.

According to some aspects, UE resource configuration circuitry 2015 transmits, to a UE, a configuration for a common CORESET on a first downlink BWP. In some examples, UE resource configuration circuitry 2015 transmits, to the UE, a configuration for one or more CSS sets within the common CORESET for PDCCH monitoring.

According to some aspects, SI transmission circuitry 2020 transmits, to the UE on the first downlink BWP, a first set of SI scheduled by a PDCCH in the one or more CSS sets. In some examples, SI transmission circuitry 2020 transmits, to the UE on a second downlink BWP, updated SI or an indication of updated SI.

In some aspects, the UE is a UE of a first type having a first set of capabilities. In some aspects, the common CORESET and the one or more CSS sets are configured for common use by UEs of the first type and UEs of a second type having a second set of capabilities. In some aspects, the second downlink BWP is configured for dedicated use by UEs of the first type in an idle state, an inactive state, or a connected state. In some aspects, transmitting the updated SI or the indication of updated SI comprises at least one of transmitting an indication that the first set of SI has changed, transmitting a notification for updated PWS information, or transmitting a response to a request by the UE for on-demand SI delivery or a combination thereof.

In some aspects, the updated SI or the indication of updated SI is transmitted in one or more search space sets associated with unicast, multicast, groupcast, or broadcast signaling. In some examples, SI transmission circuitry 2020 transmits SSBs and paging information on the first downlink BWP. In some examples, SI transmission circuitry 2020 participates with the UE in at least one of a RACH procedure, a MO data reception, or a MT data transmission procedure using the second downlink BWP and an uplink BWP linked to the second downlink BWP while the UE is in the idle state, the inactive state, or the connected state. In some aspects, transmitting the updated SI or the indication of updated SI comprises transmitting scheduling information for at least one RRC message and receiving the at least one RRC message based on the scheduling information.

In some aspects, the indication of updated SI or the updated SI is included in at least one of the scheduling information or the RRC message. In some aspects, the RRC message comprises at least one of: an RRC connection reconfiguration message, an RRC connection setup message, an RRC release message, a contention resolution message, or a random access response message. In some aspects, transmitting the updated SI or the indication of updated SI comprises transmitting scheduling information for a MT data transmission and transmitting the MT data transmission based on the scheduling information, wherein the indication of updated SI or the updated SI are included in the scheduling information, the MT data, or a combination thereof. In some aspects, transmitting the updated SI or the indication of updated SI comprises: transmitting scheduling information in one or more search space sets associated with at least one of unicast, multicast, or groupcast signaling; and transmitting a unicast, multicast, groupcast or broadcast PDSCH in accordance with the scheduling information, wherein at least one of the PDSCH or the scheduling information includes the indication of updated SI or the updated SI.

In some examples, SI transmission circuitry 2020 transmits, after transmitting the indication of updated SI to the UE on the second downlink BWP, the updated SI to the UE on the first downlink BWP. In some aspects, the indication of updated SI is transmitted via a downlink reference signal or a downlink physical channel received in the second downlink BWP via at least one of unicast, multicast, groupcast, or broadcast signaling. In some aspects, the second downlink BWP has one or more CSS sets configured for at least one of paging, PEI, or WUS. In some aspects, transmitting the updated SI or the indication of updated SI comprises transmitting the indication of updated SI in a PDCCH monitoring occasion configured for the one or more CSS sets. In some examples, SI transmission circuitry 2020 transmits, after transmitting the indication of updated SI in the PDCCH monitoring occasion, the updated SI in the first downlink BWP. In some aspects, transmitting the indication of updated SI comprises: transmitting a short message in (i) a PDCCH in the PDCCH monitoring occasion or (ii) a PDSCH scheduled by a PDCCH in the PDCCH monitoring occasion.

According to some aspects, UE SI update request circuitry 2025 receives, from the UE, a request for delivery of the updated SI or a restricted set of updated SI related to UEs of the first type in the second downlink BWP. In some aspects, receiving the request comprises receiving the request via at least one of: a PRACH, a PUSCH, a PUCCH, UCI multiplexed with PUSCH, a reference signal, or a preamble. In some examples, UE SI update request circuitry 2025 starts a timer after receiving the request for delivery of the updated SI in the second downlink BWP. In some examples, UE SI update request circuitry 2025 transmits the response to the request for delivery of the updated SI in the second downlink BWP before the timer expires.

In some examples, UE resource configuration circuitry 2015 transmits signaling for configuring the UE to perform a CG based MO data transmission procedure or a paging triggered MT data reception on the second downlink BWP while the UE is in the idle state or the inactive state. In some aspects, the network entity transmits one or more RSs suitable for at least one of: TA validation, spatial relation configuration, MO data transmission occasion validation, QCL configuration, measurements, synchronization, positioning, ranging, channel sensing, radio resource allocation or RRM in the second downlink BWP.

Notably, FIG. 20 is just one example, and many other examples and configurations of communication device are possible.

### EXAMPLE CLAUSES

Implementation examples are described in the following numbered clauses:

Clause 1: A method for wireless communication by a user equipment, the method comprising: receiving, from a network entity, a configuration for a common CORESET on a first downlink BWP; receiving, from the network entity, a configuration for one or more CSS sets within the common CORESET for PDCCH monitoring; receiving, from the network entity on the first downlink BWP, a first set of SI scheduled by a PDCCH in the one or more CSS sets; and receiving, from the network entity on a second downlink BWP, updated SI or an indication of updated SI.

Clause 2: The method of Clause 1, wherein: the UE is a UE of a first type having a first set of capabilities; the common CORESET and the one or more CSS sets are configured for common use by UEs of the first type and UEs of a second type having a second set of capabilities; and the second downlink BWP is configured for dedicated use by UEs of the first type in an idle state, an inactive state, or a connected state.

Clause 3: The method of Clause 2, wherein receiving the updated SI or the indication of updated SI comprises at least one of receiving an indication that the first set of SI has changed; receiving a notification for updated PWS information; or receiving a response to a request by the UE for on-demand SI delivery or a combination thereof.

Clause 4: The method of Clause 3, further comprising: monitoring one or more search space sets associated with unicast, multicast, groupcast, or broadcast signaling to receive at least one of the updated SI or the indication of updated SI.

Clause 5: The method of Clause 2, further comprising: receiving SSBs and paging information on the first downlink BWP; and performing at least one of a RACH procedure, a MO data transmission, or a MT data reception procedure using the second downlink BWP and an uplink BWP linked to the second downlink BWP while the UE is in the idle state, the inactive state, or the connected state.

Clause 6: The method of Clause 5, wherein: receiving the updated SI or the indication of updated SI comprises obtaining scheduling information for at least one RRC message and receiving the at least one RRC message based on the scheduling information; and the indication of updated SI or the updated SI is included in at least one of the scheduling information or the RRC message.

Clause 7: The method of Clause 6, wherein the RRC message comprises at least one of: an RRC connection reconfiguration message, an RRC connection setup message, an RRC release message, a contention resolution message, or a random access response message.

Clause 8: The method of Clause 5, wherein receiving the updated SI or the indication of updated SI comprises: obtaining scheduling information for a MT data transmission; and receiving the MT data transmission based on the scheduling information, wherein the indication of updated SI or the updated SI are included in the scheduling information, the MT data, or a combination thereof.

Clause 9: The method of Clause 5, wherein receiving the updated SI or the indication of updated SI comprises: monitoring one or more search space sets associated with at least one of unicast, multicast, or groupcast signaling; receiving a unicast, multicast, groupcast or broadcast PDSCH based on scheduling information transmitted in the one or more search space sets; and obtaining the indication of updated SI or the updated SI by decoding the PDSCH and its scheduling information.

Clause 10: The method of Clause 5, further comprising, after receiving the indication of updated SI from the network entity on the second downlink BWP, switching to the first downlink BWP to receive the updated SI.

Clause 11: The method of Clause 10, wherein: the indication of updated SI is received via a downlink reference signal or a downlink physical channel received in the second downlink BWP via at least one of unicast, multicast, groupcast, or broadcast signaling.

Clause 12: The method of Clause 2, wherein: the second downlink BWP has one or more CSS sets configured for at least one of paging, PEI, or WUS; and receiving the updated SI or the indication of updated SI comprises receiving the indication of updated SI in a PDCCH monitoring occasion configured for the one or more CSS sets.

Clause 13: The method of Clause 12, further comprising, after receiving the indication of updated SI in the PDCCH monitoring occasion, switching to the first downlink BWP to receive the updated SI.

Clause 14: The method of Clause 12, wherein receiving the indication of updated SI comprises: receiving a short message transmitted in (i) a PDCCH in the PDCCH monitoring occasion or (ii) a PDSCH scheduled by a PDCCH in the PDCCH monitoring occasion.

Clause 15: The method of Clause 14, further comprising: transmitting, to the network entity, a request for delivery of the updated SI or a restricted set of updated SI related to UEs of the first type in the second downlink BWP.

Clause 16: The method of Clause 15, wherein: transmitting the request comprises transmitting the request via at least one of: a PRACH, a PUSCH, a PUCCH, UCI multiplexed with PUSCH, a reference signal, or a preamble.

Clause 17: The method of Clause 15, further comprising: starting a timer after transmitting the request for delivery of the updated SI in the second downlink BWP; and monitoring for a response from the network entity to the request for delivery of the updated SI in the second downlink BWP until the timer expires.

Clause 18: The method of Clause 2, further comprising: receiving signaling for configuring the UE to perform a CG based MO data transmission procedure or a paging triggered MT data reception on the second downlink BWP while the UE is in the idle state or the inactive state.

Clause 19: The method of Clause 18, wherein the UE receives one or more RSs suitable for at least one of: TA validation, spatial relation configuration, MO data transmission occasion validation, QCL configuration, measurements, synchronization, positioning, ranging, channel sensing, radio resource allocation, or RRM in the second downlink BWP.

Clause 20: A method for wireless communication by a network entity, the method comprising: transmitting, to a UE, a configuration for a common CORESET on a first downlink BWP; transmitting, to the UE, a configuration for one or more CSS sets within the common CORESET for PDCCH monitoring; transmitting, to the UE on the first downlink BWP, a first set of SI scheduled by a PDCCH in the one or more CSS sets; and transmitting, to the UE on a second downlink BWP, updated SI or an indication of updated SI.

Clause 21: The method of Clause 20, wherein: the UE is a UE of a first type having a first set of capabilities; the common CORESET and the one or more CSS sets are configured for common use by UEs of the first type and UEs of a second type having a second set of capabilities; and the second downlink BWP is configured for dedicated use by UEs of the first type in an idle state, an inactive state, or a connected state.

Clause 22: The method of Clause 21, wherein transmitting the updated SI or the indication of updated SI comprises at least one of: transmitting an indication that the first set of SI has changed; transmitting a notification for updated PWS information; or transmitting a response to a request by the UE for on-demand SI delivery or a combination thereof.

Clause 23: The method of Clause 22, wherein the updated SI or the indication of updated SI is transmitted in one or more search space sets associated with unicast, multicast, groupcast, or broadcast signaling.

Clause 24: The method of Clause 21, further comprising: transmitting SSBs and paging information on the first downlink BWP; and participating with the UE in at least one of a RACH procedure, a MO data reception, or a MT data transmission procedure using the second downlink BWP and an uplink BWP linked to the second downlink BWP while the UE is in the idle state, the inactive state, or the connected state.

Clause 25: The method of Clause 24, wherein: transmitting the updated SI or the indication of updated SI comprises transmitting scheduling information for at least one RRC message and receiving the at least one RRC message based on the scheduling information; and the indication of updated SI or the updated SI is included in at least one of the scheduling information or the RRC message.

Clause 26: The method of Clause 25, wherein the RRC message comprises at least one of: an RRC connection reconfiguration message, an RRC connection setup message, an RRC release message, a contention resolution message, or a random access response message.

Clause 27: The method of Clause 24, wherein transmitting the updated SI or the indication of updated SI comprises: transmitting scheduling information for a MT data transmission; and transmitting the MT data transmission based on the scheduling information, wherein the indication of updated SI or the updated SI are included in the scheduling information, the MT data, or a combination thereof.

Clause 28: The method of Clause 24, wherein transmitting the updated SI or the indication of updated SI comprises: transmitting scheduling information in one or more search space sets associated with at least one of unicast, multicast, or groupcast signaling; and transmitting a unicast, multicast, groupcast or broadcast PDSCH in accordance with the scheduling information, wherein at least one of the PDSCH or the scheduling information includes the indication of updated SI or the updated SI.

Clause 29: The method of Clause 24, further comprising, after transmitting the indication of updated SI to the UE on the second downlink BWP, transmitting the updated SI to the UE on the first downlink BWP.

Clause 30: The method of Clause 29, wherein the indication of updated SI is transmitted via a downlink reference signal or a downlink physical channel received in the second downlink BWP via at least one of unicast, multicast, groupcast, or broadcast signaling.

Clause 31: The method of Clause 21, wherein: the second downlink BWP has one or more CSS sets configured for at least one of paging, PEI, or WUS; and transmitting the updated SI or the indication of updated SI comprises transmitting the indication of updated SI in a PDCCH monitoring occasion configured for the one or more CSS sets.

Clause 32: The method of Clause 31, further comprising, after transmitting the indication of updated SI in the PDCCH monitoring occasion, transmitting the updated SI in the first downlink BWP.

Clause 33: The method of Clause 31, wherein transmitting the indication of updated SI comprises: transmitting a short message in (i) a PDCCH in the PDCCH monitoring occasion or (ii) a PDSCH scheduled by a PDCCH in the PDCCH monitoring occasion.

Clause 34: The method of Clause 33, further comprising: receiving, from the UE, a request for delivery of the updated SI or a restricted set of updated SI related to UEs of the first type in the second downlink BWP.

Clause 35: The method of Clause 34, wherein receiving the request comprises receiving the request via at least one of a PRACH, a PUSCH, a PUCCH, UCI multiplexed with PUSCH, a reference signal, or a preamble.

Clause 36: The method of Clause 34, further comprising: starting a timer after receiving the request for delivery of the updated SI in the second downlink BWP; and transmitting the response to the request for delivery of the updated SI in the second downlink BWP before the timer expires.

Clause 37: The method of Clause 21, further comprising: transmitting signaling for configuring the UE to perform a CG based MO data transmission procedure or a paging triggered MT data reception on the second downlink BWP while the UE is in the idle state or the inactive state.

Clause 38: The method of Clause 37, wherein the network entity transmits one or more RSs suitable for at least one of: TA validation, spatial relation configuration, MO data transmission occasion validation, QCL configuration, measurements, synchronization, positioning, ranging, channel sensing, radio resource allocation or RRM in the second downlink BWP.

Clause 39: A processing system, comprising: a memory comprising computer-executable instructions; one or more processors configured to execute the computer-executable instructions and cause the processing system to perform a method in accordance with any one of Clauses 1-38.

Clause 40: A processing system, comprising means for performing a method in accordance with any one of Clauses 1-38.

Clause 41: A non-transitory computer-readable medium comprising computer-executable instructions that, when executed by one or more processors of a processing system, cause the processing system to perform a method in accordance with any one of Clauses 1-38.

Clause 42: A computer program product embodied on a computer-readable storage medium comprising code for performing a method in accordance with any one of Clauses 1-38.

### Additional Wireless Communication Network Considerations

The techniques and methods described herein may be used forvarious wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

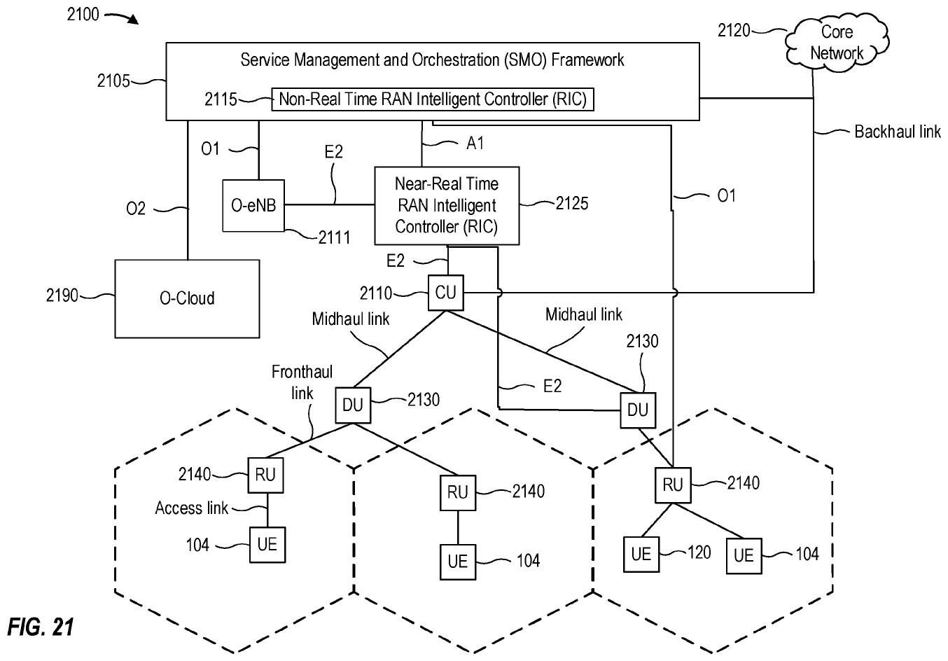

While BSs 102 are depicted in various aspects as unitary communication devices, BSs 102 may be implemented in various configurations. For example, one or more components of base station may be disaggregated, including a central unit (CU), one or more distributed units (DUs), one or more radio units (RUs), a radio unit (RU), a Near-Real Time (Near-RT) RAN Intelligent Controller (RIC), or a Non-Real Time (Non-RT) RIC, to name a few examples. In another example, various aspects of a base station may be virtualized. More generally, abase station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. In some aspects, a base station including components that are located at various physical locations may be referred to as a disaggregated radio access network architecture, such as an Open RAN (O-RAN) or Virtualized RAN (VRAN) architecture. FIG. 21 depicts and describes an example disaggregated base station architecture.

BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as BS 180 (e.g., gNB) may operate in a traditional sub-6 GHz spectrum, in millimeter wave (mmWave) frequencies, and/or near mmWave frequencies in communication with the UE 104. When the BS 180 operates in mmWave or near mmWave frequencies, the BS 180 may be referred to as an mmWave base station.

The communication links 120 between BSs 102 and, for example, UEs 104, may be through one or more carriers. For example, BSs 102 and UEs 104 may use spectrum up to YMHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communication network 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a PSSCH, and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

In various aspects, a network entity or network node can be implemented as an aggregated base station, as a disaggregated base station, an integrated access and backhaul (IAB) node, a relay node, a sidelink node, to name a few examples.

As noted above, FIG. 21 depicts an example disaggregated base station 2100 architecture. The disaggregated base station 2100 architecture may include one or more central units (CUs) 2110 that can communicate directly with a core network 2120 via a backhaul link, or indirectly with the core network 2120 through one or more disaggregated base station units (such as a Near-Real Time (Near-RT) RAN Intelligent Controller (RIC) 2125 via an E2 link, or a Non-Real Time (Non-RT) RIC 2115 associated with a Service Management and Orchestration (SMO) Framework 2105, or both). A CU 2110 may communicate with one or more distributed units (DUs) 2130 via respective midhaul links, such as an F1 interface. The DUs 2130 may communicate with one or more radio units (RUs) 2140 via respective fronthaul links. The RUs 2140 may communicate with respective UEs 104 via one or more radio frequency (RF) access links. In some implementations, the UE 104 may be simultaneously served by multiple RUs 2140.

Each of the units, i.e., the CUs 2110, the DUs 2130, the RUs 2140, as well as the Near-RT RICs 2125, the Non-RT RICs 1615 and the SMO Framework 2105, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 2110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 2110. The CU 2110 may be configured to handle user plane functionality (i.e., Central Unit-User Plane (CU-UP)), control plane functionality (i.e., Central Unit-Control Plane (CU-CP)), or a combination thereof. In some implementations, the CU 2110 can be logically split into one or more CU-UP units and one or more CU-CP units. The CU-UP unit can communicate bidirectionally with the CU-CP unit via an interface, such as the E1 interface when implemented in an O-RAN configuration. The CU 2110 can be implemented to communicate with the DU 2130, as necessary, for network control and signaling.

The DU 2130 may correspond to a logical unit that includes one or more base station functions to control the operation of one or more RUs 2140. In some aspects, the DU 2130 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 2130 may further host one or more low PHY layers. Each layer (or module) can be implemented with an interface configured to communicate signals with other layers (and modules) hosted by the DU 2130, or with the control functions hosted by the CU 2110.

Lower-layer functionality can be implemented by one or more RUs 2140. In some deployments, an RU 2140, controlled by a DU 2130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 2140 can be implemented to handle over the air (OTA) communication with one or more UEs 104. In some implementations, real-time and non-real-time aspects of control and user plane communication with the RU(s) 2140 can be controlled by the corresponding DU 2130. In some scenarios, this configuration can enable the DU(s) 2130 and the CU 2110 to be implemented in a cloud-based RAN architecture, such as a vRAN architecture.

The SMO Framework 2105 may be configured to support RAN deployment and provisioning of non-virtualized and virtualized network elements. For non-virtualized network elements, the SMO Framework 2105 may be configured to support the deployment of dedicated physical resources for RAN coverage requirements which may be managed via an operations and maintenance interface (such as an O1 interface). For virtualized network elements, the SMO Framework 2105 may be configured to interact with a cloud computing platform (such as an open cloud (O-Cloud) 2190) to perform network element life cycle management (such as to instantiate virtualized network elements) via a cloud computing platform interface (such as an O2 interface). Such virtualized network elements can include, but are not limited to, CUs 2110, DUs 2130, RUs 2140 and Near-RT RICs 2125. In some implementations, the SMO Framework 2105 can communicate with a hardware aspect of a 4G RAN, such as an open eNB (O-eNB) 2111, via an O1 interface. Additionally, in some implementations, the SMO Framework 2105 can communicate directly with one or more RUs 2140 via an O1 interface. The SMO Framework 2105 also may include a Non-RT RIC 2115 configured to support functionality of the SMO Framework 2105.

The Non-RT RIC 2115 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 2125. The Non-RT RIC 2115 may be coupled to or communicate with (such as via an A1 interface) the Near-RT RIC 2125. The Near-RT RIC 2125 may be configured to include a logical function that enables near-real-time control and optimization of RAN elements and resources via data collection and actions over an interface (such as via an E2 interface) connecting one or more CUs 2110, one or more DUs 2130, or both, as well as an O-eNB, with the Near-RT RIC 2125.

In some implementations, to generate AI/ML models to be deployed in the Near-RT RIC 2125, the Non-RT RIC 2115 may receive parameters or external enrichment information from external servers. Such information may be utilized by the Near-RT RIC 2125 and may be received at the SMO Framework 2105 or the Non-RT RIC 2115 from non-network data sources or from network functions. In some examples, the Non-RT RIC 2115 or the Near-RT RIC 2125 may be configured to tune RAN behavior or performance. For example, the Non-RT RIC 2115 may monitor long-term trends and patterns for performance and employ AI/ML models to perform corrective actions through the SMO Framework 2105 (such as reconfiguration via O1) or via creation of RAN management policies (such as A1 policies).

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a PSSCH.

Transmit processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH DMRS, and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a RB, may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A, 3B, 3C, and 3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through RRC signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A, 3B, 3C, and 3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a RB (also referred to as physical RBs (PRBs)) that extends 12 consecutive subcarriers. The resource grid is divided into multiple REs. The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100× is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### Additional Considerations

The preceding description provides examples of updated SI delivery in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UNITS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a user equipment (as in the example UE 104 of FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. An apparatus for wireless communication at a user equipment (UE), comprising:
one or more memories comprising instructions; and
one or more processors configured to execute the instructions and cause the UE to:
receive, from a network entity, a configuration for a common control resource set (CORESET) on a first downlink bandwidth part (BWP) and
receive, from the network entity, a configuration for one or more common search space (CSS) sets within the common CORESET for physical downlink control channel (PDCCH) monitoring;
receive, from the network entity on the first downlink BWP, a first set of system information (SI) scheduled by a physical downlink control channel (PDCCH) in the one or more CSS sets; and
receive, from the network entity on a second downlink BWP, updated SI or an indication of updated SI.

2. The apparatus of claim 1, wherein:
the UE is a UE of a first type having a first set of capabilities;
the common CORESET and the one or more CSS sets are configured for common use by UEs of the first type and UEs of a second type having a second set of capabilities; and
the second downlink BWP is configured for dedicated use by UEs of the first type in an idle state, an inactive state, or a connected state.

3. The apparatus of claim 2, wherein receiving the updated SI or the indication of updated SI comprises at least one of:
receiving an indication that the first set of SI has changed;
receiving a notification for updated public warning system (PWS) information; or
receiving a response to a request by the UE for on-demand SI delivery or a combination thereof.

4. The apparatus of claim 3, wherein the one or more processors are further configured to execute the instructions and cause the UE to:
monitor one or more search space sets associated with unicast, multicast, groupcast, or broadcast signaling to receive at least one of the updated SI or the indication of updated SI.

5. The apparatus of claim 2, wherein the one or more processors are further configured to execute the instructions and cause the UE to:
receive synchronization signal blocks (SSBs) and paging information on the first downlink BWP; and
perform at least one of a random access channel (RACH) procedure, a mobile originated (MO) data transmission, or a mobile terminated (MT) data reception procedure using the second downlink BWP and an uplink (UL) BWP linked to the second downlink BWP while the UE is in the idle state, the inactive state, or the connected state.

6. The apparatus of claim 5, wherein:
receiving the updated SI or the indication of updated SI comprises obtaining scheduling information for at least one radio resource control (RRC) message and receiving the at least one RRC message based on the scheduling information; and
the indication of updated SI or the updated SI is included in at least one of the scheduling information or the RRC message.

7. The apparatus of claim 6, wherein the RRC message comprises at least one of: an RRC connection reconfiguration message, an RRC connection setup message, an RRC release message, a contention resolution message, or a random access response message.

8. The apparatus of claim 5, wherein receiving the updated SI or the indication of updated SI comprises:
obtaining scheduling information for a mobile terminated (MT) data transmission; and
receiving the MT data transmission based on the scheduling information,
wherein the indication of updated SI or the updated SI are included in the scheduling information, the MT data, or a combination thereof.

9. The apparatus of claim 5, wherein receiving the updated SI or the indication of updated SI comprises:
monitoring one or more search space sets associated with at least one of unicast, multicast, or groupcast signaling;
receiving a unicast, multicast, groupcast or broadcast physical downlink shared channel (PDSCH) based on scheduling information transmitted in the one or more search space sets; and
obtaining the indication of updated SI or the updated SI by decoding the PDSCH and its scheduling information.

10. The apparatus of claim 5, wherein the one or more processors are further configured to execute the instructions and cause the UE to, after receiving the indication of updated SI from the network entity on the second downlink BWP:
switch to the first downlink BWP to receive the updated SI.

11. The apparatus of claim 10, wherein the indication of updated SI is received via a downlink reference signal or a downlink physical channel received in the second downlink BWP via at least one of unicast, multicast, groupcast, or broadcast signaling.

12. The apparatus of claim 2, wherein:
the second downlink BWP has one or more common search space (CSS) sets configured for at least one of paging, paging early indication (PEI), or wake up signals (WUS); and
receiving the updated SI or the indication of updated SI comprises receiving the indication of updated SI in a PDCCH monitoring occasion configured for the one or more CSS sets.

13. The apparatus of claim 12, wherein the one or more processors are further configured to execute the instructions and cause the UE to, after receiving the indication of updated SI in the PDCCH monitoring occasion:
switch to the first downlink BWP to receive the updated SI.

14. The apparatus of claim 12, wherein receiving the indication of updated SI comprises:
receiving a short message transmitted in (i) a PDCCH in the PDCCH monitoring occasion or (ii) a physical downlink shared channel (PDSCH) scheduled by a PDCCH in the PDCCH monitoring occasion.

15. The apparatus of claim 14, wherein the one or more processors are further configured to execute the instructions and cause the UE to:
transmit, to the network entity, a request for delivery of the updated SI or a restricted set of updated SI related to UEs of the first type in the second downlink BWP.

16. The apparatus of claim 15, wherein transmitting the request comprises transmitting the request via at least one of: a physical random access channel (PRACH), a physical uplink shared channel (PUSCH), physical uplink control channel (PUCCH), uplink control information (UCI) multiplexed with PUSCH, a reference signal, or a preamble.

17. The apparatus of claim 15, wherein the one or more processors are further configured to execute the instructions and cause the UE to:
start a timer after transmitting the request for delivery of the updated SI in the second downlink BWP; and
monitor for a response from the network entity to the request for delivery of the updated SI in the second downlink BWP until the timer expires.

18. The apparatus of claim 2, wherein the one or more processors are further configured to execute the instructions and cause the UE to:
receive signaling for configuring the UE to perform a configured grant (CG) based mobile originated (MO) data transmission procedure or a paging triggered mobile terminated (MT) data reception on the second downlink BWP while the UE is in the idle state or the inactive state.

19. The apparatus of claim 18, wherein the UE receives one or more reference signals (RS) suitable for at least one of: timing advance (TA) validation, spatial relation configuration, MO data transmission occasion validation, quasi co-location (QCL) configuration, measurements, synchronization, positioning, ranging, channel sensing, radio resource allocation, or radio resource management (RRM) in the second downlink BWP.

20. An apparatus for wireless communication at a network entity, comprising:
one or more memories comprising instructions; and
one or more processors configured to execute the instructions and cause the network entity to:
transmit, to a user equipment (UE), a configuration for a common control resource set (CORESET) on a first downlink bandwidth part (BWP) and
transmit, to the UE, a configuration for one or more common search space (CSS) sets within the common CORESET for physical downlink control channel (PDCCH) monitoring;
transmit, to the UE on the first downlink BWP, a first set of system information (SI) scheduled by a physical downlink control channel (PDCCH) in the one or more CSS sets; and
transmit, to the UE on a second downlink BWP, updated SI or an indication of updated SI.

21. The apparatus of claim 20, wherein:
the UE is a UE of a first type having a first set of capabilities;
the common CORESET and the one or more CSS sets are configured for common use by UEs of the first type and UEs of a second type having a second set of capabilities; and
the second downlink BWP is configured for dedicated use by UEs of the first type in an idle state, an inactive state, or a connected state.

22. The apparatus of claim 21, wherein transmitting the updated SI or the indication of updated SI comprises at least one of:
transmitting an indication that the first set of SI has changed;
transmitting a notification for updated public warning system (PWS) information; or
transmitting a response to a request by the UE for on-demand SI delivery or a combination thereof.

23. (canceled)

24. The apparatus of claim 21, wherein the one or more processors are further configured to execute the instructions and cause the network entity to:
transmit synchronization signal blocks (SSBs) and paging information on the first downlink BWP; and
participate with the UE in at least one of a random access channel (RACH) procedure, a mobile originated (MO) data reception, or a mobile terminated (MT) data transmission procedure using the second downlink BWP and an uplink (UL) BWP linked to the second downlink BWP while the UE is in the idle state, the inactive state, or the connected state.

25. The apparatus of claim 24, wherein:
transmitting the updated SI or the indication of updated SI comprises transmitting scheduling information for at least one radio resource control (RRC) message and receiving the at least one RRC message based on the scheduling information; and
the indication of updated SI or the updated SI is included in at least one of the scheduling information or the RRC message.

26. (canceled)

27. The apparatus of claim 24, wherein transmitting the updated SI or the indication of updated SI comprises:
transmitting scheduling information for a mobile terminated (MT) data transmission; and
transmitting the MT data transmission based on the scheduling information, wherein
the indication of updated SI or the updated SI are included in the scheduling information, the MT data, or a combination thereof; or
transmitting scheduling information in one or more search space sets associated with at least one of unicast, multicast, or groupcast signaling, and
transmitting a unicast, multicast, groupcast or broadcast physical downlink shared channel (PDSCH) in accordance with the scheduling information, wherein at least one of the PDSCH or the scheduling information includes the indication of updated SI or the updated SI.

28. (canceled)

29. The method of claim 24, wherein the one or more processors are further configured to execute the instructions and cause the network entity to, after transmitting the indication of updated SI to the UE on the second downlink BWP:
transmit the updated SI to the UE on the first downlink BWP.

30. (canceled)

31. The method of claim 21, wherein:
the second downlink BWP has one or more common search space (CSS) sets configured for at least one of paging, paging early indication (PEI), or wake up signals (WUS); and
transmitting the updated SI or the indication of updated SI comprises transmitting the indication of updated SI in a PDCCH monitoring occasion configured for the one or more CSS sets.

32-36. (canceled)

37. The method of claim 21, wherein the one or more processors are further configured to execute the instructions and cause the network entity to:
transmit signaling for configuring the UE to perform a configured grant (CG) based mobile originated (MO) data transmission procedure or a paging triggered mobile terminated (MT) data reception on the second downlink BWP while the UE is in the idle state or the inactive state.

38-42. (canceled)

43. A method for wireless communication by a user equipment (UE), comprising:
receiving, from a network entity, a configuration for a common control resource set (CORESET) on a first downlink bandwidth part (BWP) and
receiving, from the network entity, a configuration for one or more common search space (CSS) sets within the common CORESET for physical downlink control channel (PDCCH) monitoring;
receiving, from the network entity on the first downlink BWP, a first set of system information (SI) scheduled by a physical downlink control channel (PDCCH) in the one or more CSS sets; and
receiving, from the network entity on a second downlink BWP, updated SI or an indication of updated SI.

44. A method for wireless communication by a network entity, comprising:
transmitting, to a user equipment (UE), a configuration for a common control resource set (CORESET) on a first downlink bandwidth part (BWP) and
transmitting, to the UE, a configuration for one or more common search space (CSS) sets within the common CORESET for physical downlink control channel (PDCCH) monitoring;
transmitting, to the UE on the first downlink BWP, a first set of system information (SI) scheduled by a physical downlink control channel (PDCCH) in the one or more CSS sets; and
transmitting, to the UE on a second downlink BWP, updated SI or an indication of updated SI.
